(19) United States
(12) Patent Application Publication
(10) Pub. No.: US 2017/0083109 A1
(43) Pub. Date: Mar. 23, 2017

(54) KEYBOARD AND MOUSE OF HANDHELD DIGITAL DEVICE

(71) Applicants: Yonggui Li, Qingdao (CN); Kun Li, Qingdao (CN)

(72) Inventors: Yonggui Li, Qingdao (CN); Kun Li, Qingdao (CN)

(21) Appl. No.: 15/356,639

(22) Filed: Nov. 20, 2016

Related U.S. Application Data
(63) Continuation-in-part of application No. 14/555,660, filed on Nov. 27, 2014.
Application No. 14/555,660 is a continuation-in-part of application No. PCT/CN2013/075887, filed on May 20, 2013.

(30) Foreign Application Priority Data
Nov. 30, 2015 (CN) 201510861828.0
Jan. 6, 2016 (CN) PCT/CN2016/070222
May 6, 2016 (US) 15149074

(51) Int. Cl. G06F 3/023; G06F 3/0488; G06F 3/041

(52) U.S. Cl. CPC G06F 3/0238; G06F 3/041; G06F 3/04886; G06F 2203/0381; G06F 2203/04104

(57) ABSTRACT

A keyboard for a handheld device comprises a plurality of side-keys and a main keyboard. The side-keys are configured at one side(s) and/or back of the device and used for changing layout of the main keyboard and operated by one hand holding the device. The main keyboard is used for inputting characters/commands and operated by another hand. Some or all of the side-keys can also be re-used as mouse buttons together with a touch screen of the device being re-used as a touch pad for a mouse. Some or all of the side-keys are operated by means of releasing a finger holding a side-key first and then using the finger to press down or touch the side-key to hold it again. This method operating a side-key can also be used for other key/buttons such as mouse buttons of a touch mouse, a touch-pad mouse, etc. The main keyboard can further comprise a physical keyboard and a mapping keyboard configured on a touch screen of the device to realize much more keys by means of simultaneously pressing down and releasing two or more keys of the physical keyboard. A current layout of the physical keyboard is mapped to the mapping keyboard.

### CROSS-REFERENCE TO RELATED APPLICATIONS

This application claims the benefit of or priority to the following applications:

China application No. CN 201210291364.0, filed on Aug. 9, 2012, entitled “Keyboard of Cellular Phone”;

China application No. CN 201220724909.8, filed on Dec. 24, 2012, entitled “Keyboard and Mouse of Cellular Phone”;

PCT application No. PCT/CN2013/075887, filed on May 20, 2013, entitled “Keyboard and Mouse of Cellular Phone”;

China application No. CN 201510861828.0, filed on Nov. 30, 2015, entitled “A method realizing a plurality of keys/buttons in a multi-touch pad, which positions are determined dynamically and passively”;

PCT application No. PCT/CN2016/070222, filed on Jan. 6, 2016, entitled “A method realizing a plurality of keys/buttons which positions are determined dynamically and passively”;

U.S. application Ser. No. 15/149,074, filed on May 6, 2016, entitled “A method realizing a plurality of keys/buttons which positions are determined dynamically and passively”.

The above-identified applications are incorporated here by reference in entirety or part.

### TECHNICAL FIELD

A keyboard and mouse solution is used for handheld digital devices (such as cellular phones, tablets, eBooks, electronic dictionaries, learning machines, and handheld control devices etc. A handheld digital device is hereinafter referred to as a device). For ease of description, cellular phones are taken as examples to explain and illustrate handheld digital devices with small size, and tablets are taken as examples to explain and illustrate handheld digital devices with large size. Due to the symmetry of one's hands, where the solution is explained and illustrated by means of left-right hands below, it can also be realized by means of right-left hands in turn, so unless it is necessary, explanation and illustration are no longer given by means of right-left hands. This keyboard and mouse solution is hereinafter referred to as the solution.

### BACKGROUND ART

Currently, (1) There are three main kinds of cellular phone keyboard solutions: \textcircled{1} A dialing keyboard plus additional control and edit keys, the keys of which are too few to meet the requirements of increasingly powerful cellular phone applications; \textcircled{2} A smaller version of a PC keyboard. Because of the small size of cellular phones, the keys of this type of keyboard is too crowded to be convenient to use; \textcircled{3} A QWERT keyboard is a simplified version of a PC keyboard which only keep the letter keys. Even though the keys reduce in quantity, the QWERT keyboard cannot yet be compatible with cellular phones with small size, and the keys are still crowded to be inconvenient to use. (2) A tablet uses a soft QWERT keyboard basically. Even though a single key is big enough, the keys of each row can be up to 10 at most, and moreover the keyboard is not a hard one, so a user cannot position his/her fingers easily and touch type at a high speed. (3) Neither cellular phones nor tablets have a device like a mouse.

Anyway, the main technical problems of keyboard and mouse of a handheld digital device are currently: \textcircled{1} A user cannot use most of the fingers of the two hands simultaneously with a keyboard. In most cases, the user uses only one finger of a single hand, at most the two thumbs of the two hands; \textcircled{2} The keys of the keyboard are small either in size or in quantity, or the keys of each row are too much (refers to a QWERT keyboard of a tablet), so the keyboard is not fit for touch typing at a high speed; \textcircled{3} There is no good hand feel because of the soft keyboard used by most of handheld digital devices. \textcircled{4} There is not any powerful tool like a mouse, and moreover touch operations often result in wrong actions; \textcircled{5} In the absence of a mouse, there is not any accurate positioning tool like a mouse pointer, and many mature PC applications such as word processing software cannot be effectively used with a handheld digital device, and some PC applications such as senior drawing software maybe cannot be transferred to a handheld digital device forever; \textcircled{6} In the absence of appropriate control keys, no shortcuts can be used like a PC keyboard; \textcircled{7} Taking no account of the compatibility with a PC keyboard, there will be troubles in the PC application's transference to a handheld digital device when the device developments to become a personal computing center in the future.

The followings to the end of this section are added newly in this continuation-in-part application.

A US application US2002/0163504 disclosed a keyboard for a hand-held device comprising multiple keys on the face (“face-keys”) of the device and one or more buttons on the side (“side-buttons”) of the device. A user types a character (or invokes a function) by pressing one of the face-keys using a finger on the hand that is not holding the device while simultaneously holding in combinations of the side-buttons with fingers on the hand that is holding the device. Pressing a face-key without holding in any of the side-keys produces a given character (or function). Pressing the same face-key while simultaneously holding in a given combination of the side-keys can result in a different character (or function).

This invention is the most similar to the present invention, but the side-buttons (keys) are operated via a popular and traditional method, it is not user-friendly. The side-buttons are not holding positions of the hand-held device and the fingers operating the side-buttons hang in the air when not in operation. This results in operating the side-buttons very uncomfortably and un-easily and holding the hand-held device unsafely and un-firmly.

### BRIEF SUMMARY OF THE INVENTION

In order to solve the technical problems mentioned above, the technical solution of this invention is: (1) On the side(s) (including the back, top side and the other locations) of a handheld digital device or main keyboard of the device, we configure additional keyboard control keys (hereinafter referred to as side-keys) which are operated by left hand. Besides the conventional PC keyboard control keys: Shift, Ctrl and Alt, 4 new control keys named as Fvrt, Eng, Num and Ext are configured, which are shown as 3 in FIGS. 1 and 4 in FIG. 3. Fvrt is short for favorite and used to enter a user's mother tongue or the common second language of an English user. Eng is short for English and used to enter English letters. Num is the abbreviation of number and used to enter numbers and English punctuations. Ext is the abbreviation of extension and for the extension inputs such as the inputs of the third language or what the user customs or what the vendor defines or the omitted F1-F2 etc. of a PC keyboard. These 4 side-keys expand the functionality of each single key of the main keyboard. When they are operated together with the Shift key, each key of the main keyboard can be used as 4*2=8 keys. This is just why the solution has enough keys and assures that the keys are moderate in size. In addition, a 2Hands key can be configured too as 3 in FIG. 1. (2) A main keyboard is configured with the device, which uses a 5*6(rows*columns) key matrix and is operated by right hand. The keyboard has at least 5*6*4*2=240 kinds of possible inputs theoretically. In contrast, a PC keyboard has only about 100 kinds of inputs. In this way, the keyboard is more powerful than a PC keyboard except that the operations are of a bit more trouble than a PC keyboard. (3) A simulated mouse has 3 sets of solutions able to be used simultaneously: \textcircled{1} Num, Eng and Fvrt are redefined and reused as the left, right and middle simulated mouse buttons, and the simulated mouse is simulated by a finger touching and/or sliding on the touch display screen/touch screen/touch pad(the touch display screen is taken as an example to describe the simulated mouse solution below)of the handheld digital device. \textcircled{2} By means of multi-touch technology, we can define the fingers clicking on the touch display screen at the left and right of the finger simulating the mouse respectively as the left and right simulated mouse buttons, and define two fingers sliding side by side on the touch display screen as the middle simulated mouse button. The middle simulated mouse button can also be simulated by means of one finger touching and sliding together with another finger touching and staying on the touch display screen. \textcircled{3} With the aid of side-keys and/or fingers, a touch pen can also be used to simulate a mouse.

If the side-keys are integrated into the main keyboard, the keyboard becomes a one-hand keyboard with which we still can touch type at a high speed; by applying the solution, a tablet combined with a hard keyboard becomes a hard keyboard tablet; By means of the solution, we can also combine a hard keyboard with a touch pad/touch screen/touch display screen to become a portable handheld keyboard; with the solution, we can also easily convert a handheld digital device to a handheld keyboard; finally, we can also make a cellular phone keyboard case applying the solution by the combination of a hard keyboard and a cellular phone case.

The beneficial effects of the solution are very obvious: We can touch type at a high speed with a handheld digital device by two hands at the same time; the solution realizes the function of a mouse on a touch display screen/touch screen/touch pad; the solution also provides conveniences for the PC application's transference to a handheld digital device.

The followings to the end of this section are added newly in this continuation-in-part application.

The side-keys are also holding positions of the hand-held digital device, the hand-held digital device is held through holding the side-keys. The side-keys are operated by means of releasing a finger holding a side-key first and then using the finger to press down or touch the key to hold the key again. By this method, a side-key is held both before and after an operation and is released for an instant or a period of time only in the middle of the operation. In this way, not only the handheld digital device can be held firmly and safely, but also the side-keys can be operated comfortably and easily.

### BRIEF DESCRIPTION OF THE DRAWINGS

FIG. 1 is a left view of a cellular phone; FIG. 2 is a front view of the phone; FIG. 3 is a right view of the phone.

FIG. 4 is a front view of a cellular phone; FIG. 5 is a partial back view of the phone.

FIG. 6 is a perspective view of a bar phone.

FIG. 7 is a perspective view of a slide phone.

FIG. 8 is a perspective view of a flip phone.

FIG. 9 is a left view of a bar phone; FIG. 10 is a perspective view of the bar phone.

FIGS. 11-14 are four main keyboard layouts.

FIG. 15 is four key row layouts of main keyboard; FIG. 16 is corresponding section views of the four key row layouts.

FIG. 17 is the other three key row layouts of main keyboard.

FIG. 18-20, FIG. 22-23 are five main keyboard layouts. In layout 18, Math means math symbols, Order means ordinal numbers, Date means various formats of current date, Greek means Greek letters, Cstm is short for custom and means custom symbols, and More means more symbols, each of these keys triggers a nested sub layout or a menu when pressed. In layout 19-3 of a remote, Scr is short for Source and used as a signal source key, Def is for definition, aMode is for audio mode, iMode is for image mode, Dos for data on screen, fave for favorite programs, Frz for freeze.

FIG. 21 is a touch pad layout.

FIGS. 24-29 are six main keyboard layouts. In layout 24-2 and 24-3, italic mt is short for math, od for order, dt for date, gk for Greek, ct for custom, mr for more.

FIG. 30-34 are five main keyboard layouts of a 4*4 matrix hard main keyboard cellular phone; FIG. 35 is a partial left view of the phone; FIG. 36 is a perspective view of the phone; FIG. 37 is a partial right view of the phone.

FIG. 38-42 are five main keyboard layouts of a 3*5 matrix hard main keyboard cellular phone; FIG. 43 is a partial left view of the phone; FIG. 44 is a perspective view of the phone; FIG. 45 is a partial right view of the phone.

FIG. 46 is a partial back view of a cellular phone.

FIGS. 47-51 are five main keyboard layouts of a hard main keyboard cellular phone with 2*6 matrix; FIG. 52 is a partial left view of the phone; FIG. 53 is a perspective view of the phone; FIG. 54 is a partial right view of the phone.

FIG. 55-59 are five main keyboard layouts of a hard main keyboard cellular phone with 2*5 matrix; FIG. 60 is a perspective view of the phone; FIG. 61 is a right view of the phone.

FIG. 62-65 are four main keyboard layouts of a hard main keyboard cellular phone with extension keys and the main keyboard of which have a 2*6 matrix; FIG. 66 is a partial left view of the phone; FIG. 67 is a perspective view of the phone; FIG. 68 is a partial right view of the phone.

FIG. 69-70 are two main keyboard layouts of a hard main keyboard cellular phone with extension keys and the main keyboard of which have a 2*5 matrix; FIG. 71 is a perspective view of the phone.

FIG. 72-75 are four main keyboard layouts of a hard main keyboard cellular phone with extension keys and the main keyboard of which have a 1*6 matrix; FIG. 76 is a partial left view of the phone; FIG. 77 is a perspective view of the phone; FIG. 78 is a partial right view of the phone.

FIG. 79-80 are two main keyboard layouts of a hard main keyboard cellular phone with extension keys and the main keyboard of which have a 1*5 matrix; FIG. 81 is a perspective view of the phone.

FIGS. 82-86 are perspective views of five kinds of tablets with different side-key layouts; FIG. 87 is a back view of FIG. 86 tablet.

FIGS. 88 and 90 are perspective views of two kinds of tablets with different side-key layouts; FIG. 89 is a back view of FIG. 88 tablet; FIG. 91 is a back view of FIG. 90 tablet.

FIGS. 92, 95 and 96 are perspective views of three kinds of tablets with different hard main key board layouts or different character dynamically-mapping zones; FIG. 93 is a back view of FIG. 92 tablet; FIG. 94 is a layout of a character dynamically-mapping zone of FIG. 95 tablet; FIG. 97 is a back view of FIG. 96 tablet.

FIGS. 98 and 100 are perspective views of two kinds of hard keyboard tablets with multiple set of side-keys; FIG. 99 is a back view of FIG. 98 tablet; FIG. 101 is a back view of FIG. 100 tablet.

FIGS. 102-103, FIG. 104-105 and FIG. 106 are three kinds of cellular phone side-key layouts.

FIGS. 107 and 113 are perspective views of two kinds of foldable hard keyboard tablets; FIG. 108 is a perspective view of FIG. 107 tablet standing on its keyboard; FIG. 109 is a back view of FIG. 107 tablet standing with a touch pen; FIG. 110 is a perspective view of a body of FIG. 107 tablet; FIG. 111 is a perspective view of a hard keyboard of FIG. 107 or 113 tablet; FIG. 112 is a partial enlarged view of FIG. 111 hard keyboard; FIG. 114 is another partial enlarged view of FIG. 111 hard keyboard.

FIG. 115 is a perspective view of another foldable hard keyboard tablet; FIG. 116 is a perspective view of FIG. 115 tablet standing on its keyboard; FIG. 117 is a perspective view of a hard keyboard of FIG. 115 tablet.

FIG. 118 is a perspective view of a foldable hard keyboard cellular phone.

FIGS. 119 and 123 are perspective views of two kinds of flip hard keyboard tablets; FIGS. 120 and 121 are two back views of FIG. 119 or 123 tablet; FIG. 122 is a perspective view of a flip hard keyboard of FIG. 119 or 123 tablet.

FIG. 124 is a perspective view of a transparent flip hard keyboard tablet with a keyboard cover; FIGS. 125, 126 and 127 are three perspective views of FIG. 124 tablet standing; FIG. 128 is a back view of the tablet; FIG. 129 is perspective view of a flip hard keyboard of the tablet.

FIG. 130 is a perspective view of a flip hard keyboard cellular phone.

FIGS. 131-136 are front views of a tablet.

FIG. 137 is a front view of a handheld keyboard; FIG. 138 is a perspective view of a bar handheld keyboard; FIG. 139 is a perspective view of a flip handheld keyboard; FIG. 140 is a perspective view of a double-face handheld keyboard; FIG. 141 is a left view of FIG. 140 keyboard; FIG. 142 is a right view of FIG. 140 keyboard; FIG. 143 is a partial enlarged view of FIG. 140 keyboard; FIG. 144 is a back view of FIG. 140 keyboard.

FIG. 145-149 are five kinds of cellular phone keyboard cases.

FIG. 150 is a left view of FIG. 151 mobile phone; FIG. 151 is a front view of a mobile phone; FIG. 152 is a right view of FIG. 151 mobile phone; FIG. 153-155 are front views of FIG. 151 mobile phone held and operated by a left hand.

FIG. 156-158 are front views of FIG. 160 mouse held and operated by a right hand; FIG. 159 is a left view of FIG. 160 mouse; FIG. 160 is a top view of a touch mouse; FIG. 161 is a right view of FIG. 160 mouse.

FIG. 162 is a left view of FIG. 163 mouse; FIG. 163 is a top view of a touch mouse; FIG. 164 is a right view of FIG. 163 mouse.

FIG. 165 is a left view of FIG. 166 mouse; FIG. 166 is a top view of a touch mouse with a wheel; FIG. 167 is a right view of FIG. 166 mouse.

FIG. 168 is a left view of FIG. 169 mouse; FIG. 169 is a top view of a touch mouse with a wheel; FIG. 170 is a right view of FIG. 169 mouse.

FIG. 171 is a left view of FIG. 172 mouse; FIG. 172 is a top view of a mouse with six physical buttons; FIG. 173 is a right view of FIG. 172 mouse.

FIG. 174 is a left view of FIG. 175 mouse; FIG. 175 is a top view of a mouse with three physical buttons and three touch buttons; FIG. 176 is a right view of FIG. 175 mouse.

FIG. 177 is a top view of a touch-pad mouse; FIG. 178 is a right view of FIG. 177 mouse; FIG. 179-181 are front views of FIG. 177 touch-pad mouse operated by a right hand; FIG. 182-186 are top views of FIG. 177 touch-pad mouse showing right-hand touch-gesture models.

FIG. 187 is a left view of FIG. 188 mobile phone; FIG. 188 is a stereo view of a mobile phone; FIG. 189 is a right view of FIG. 188 mobile phone; FIG. 190 is a front view of FIG. 188 mobile phone with a mapping keyboard opened; FIG. 191-198 are layouts of a physical keyboard of FIG. 188 mobile phone.

### DETAILED DESCRIPTION OF THE INVENTION

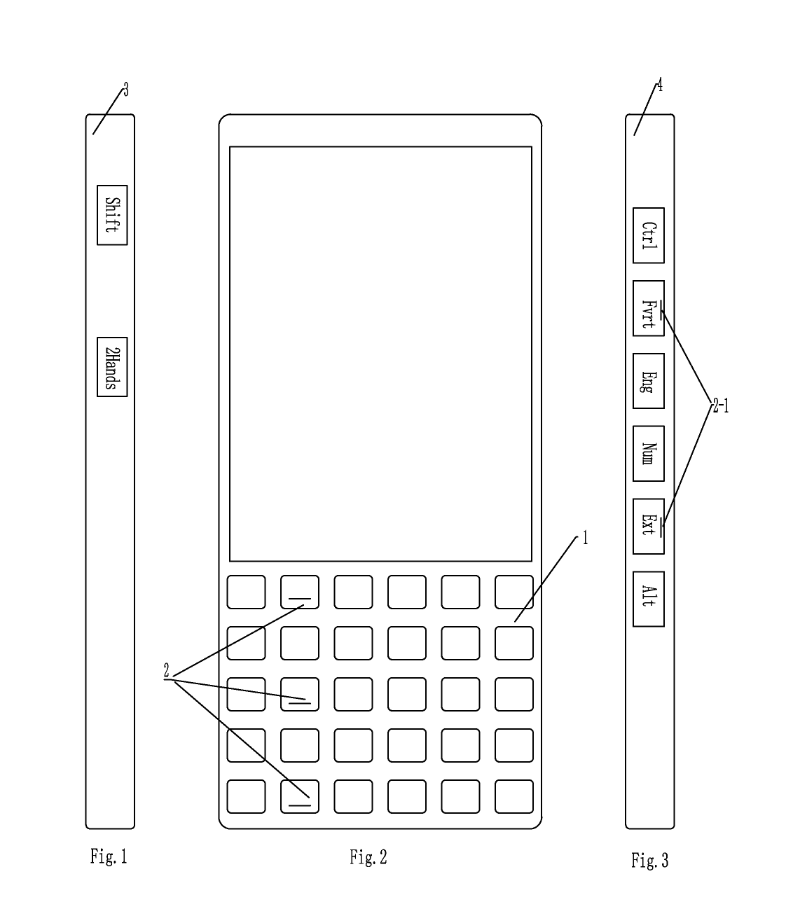

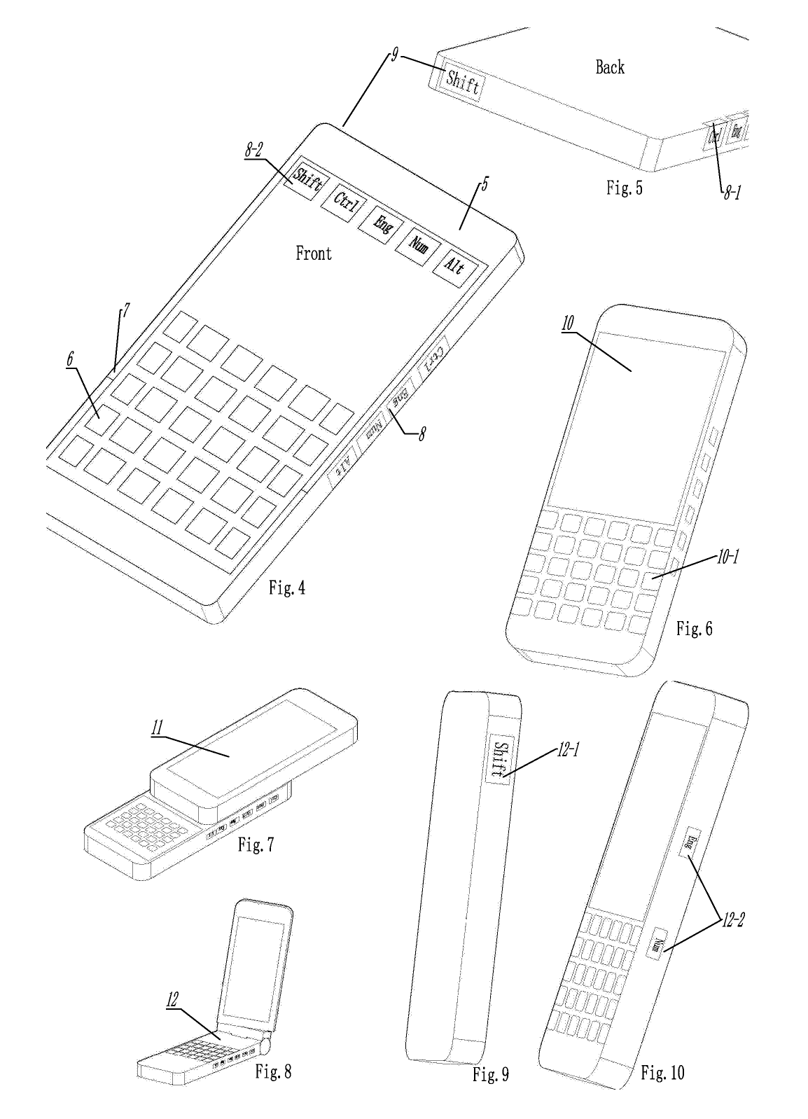

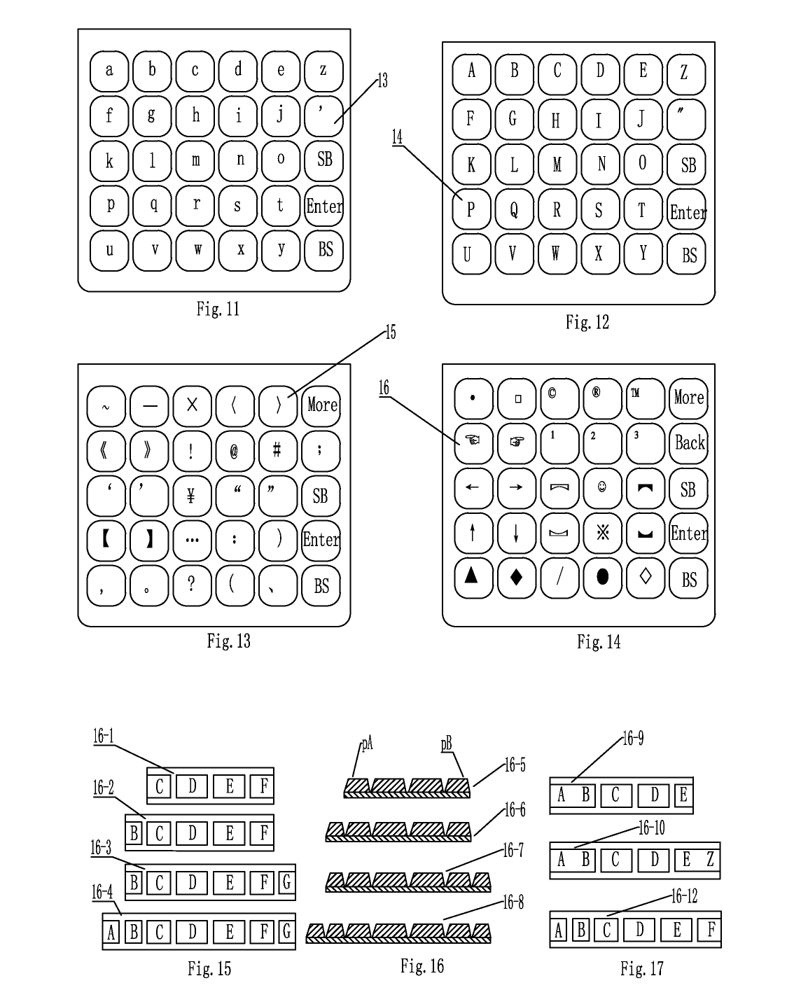

(A) Main keyboard. (a) Hard main keyboard. The main keyboard of the solution can be either a physical hard keyboard or a touch-control soft keyboard. In the case of a hard keyboard, standard hard keyboard layout 24-2 in FIG. 28, 24-3 in FIG. 29 or 75-1 in FIG. 137 is preferred. In addition, in order to prompt the user to input the other characters not tagged on the keys of the main keyboard and of nested sub-layouts, those characters should be mapped onto the display screen of the device receiving input with the aid of the operating system and/or the input method of the device. An example is shown as character dynamically-mapping zone 57-3 in FIG. 123. Finger positioning marks should be marked on a plurality of keys in a hard keyboard as 2 in FIG. 2, 21-1 in FIG. 24, 22-1 in FIGS. 25 and 24-11 in FIG. 36 to facilitate the user to position his/her fingers. A hard keyboard should provide a function for use at the dark.

(b) Soft main keyboard. The finger positioning marks of a soft main keyboard of a cellular phone can be marked on the borders as 7 in FIG. 4. A soft main keyboard of a tablet should allow the user to slide on the touch display screen to a proper place to facilitate the user to input. A soft main keyboard layout should use one of the standard layouts in FIGS. 11-14 and FIGS. 18-23, which changes depending on the side-key currently pressed(The layouts of the other mother tongues and languages corresponding to Fvrt should be established by the respective OS and/or input method).

(c) Main keyboard matrix. In order to meet the requirement of touch typing at a high speed by multiple fingers of a single hand, a main keyboard had better be a physical hard keyboard using a key matrix with 1/2/3/4/5/6/ row(s) and 4/5/6 columns. Taking account of the usage consistency between cellular phones and tablets, a main keyboard had better use a key matrix of 5*6 as 1 in FIG. 2, 2*6 as 24-C8 in FIG. 67, 2*5 as 24-C13 in FIG. 71, 1*6 as 24-E11 in FIG. 77, 1*5 as 24-E13 in FIG. 81. However, due to a great variety of handheld digital devices, 6*6 matrix as 22 in FIG. 25, 6*5 matrix as 21 in FIG. 24, 4*4 matrix as 24-4 in FIG. 30, 3*5 matrix as 24-A3 in FIG. 44, 4*7, 2*7, 1*7(rows*columns) and the other reasonable matrixes not listed here are applicable and optional.

(1) 24-9 in FIG. 36 is a 4*4 matrix hard main keyboard cellular phone. 24-4, 24-5, 24-6, 24-7 and 24-7S are main keyboard layouts respectively corresponding to side-keys: En1, En2, Num, Punc (short for punctuation) and Punc+Shift. Shift key 24-8 is configured on the upper of the left side of the device. Seven side-keys 24-10: Fvrt, Ctrl, En1, En2, Num, Punc and Alt are configured on the right side of the device. This Fvrt key is only used to switch between English and another language. Finger positioning marks 24-10A are configured on En1 and Punc. En1 is the default key pressed/touched by the fore finger of the left hand and Punc is the default key pressed/touched by the little finger of the left hand. Fvrt and Ctrl are pressed/touched by fore finger moving upwards. Alt is pressed/touched by little finger moving downwards. In addition, the side-key names: En1 and En2 can be replaced by the first letter of the corresponding main keyboard layout, for example, in this 4*4 matrix solution, they are replaced by A and N.

(2) 24-A2 in FIG. 44 is a 3*5 matrix hard main keyboard cellular phone. The given 5 main keyboard layouts correspond to side-keys: En1, En2, Num, Punc and Punc+Shift respectively. Seven side-keys 24-A4: Enter, Ctrl, En1, En2, Num, Punc and Alt are configured on the right side and Shift key is configured on the left side. 24-A5 is of finger positioning marks. The second key of each row of the main keyboard is the default key pressed by the fore finger of the right hand. The keys of main keyboard 24-A3 can be reused for the other purposes when the device is held by a single hand or not in edit/shortcut mode, for example, what are mapped in the middle keys are common keys of a feature phone. The word PhBk at the lower left corner is short for phone book.

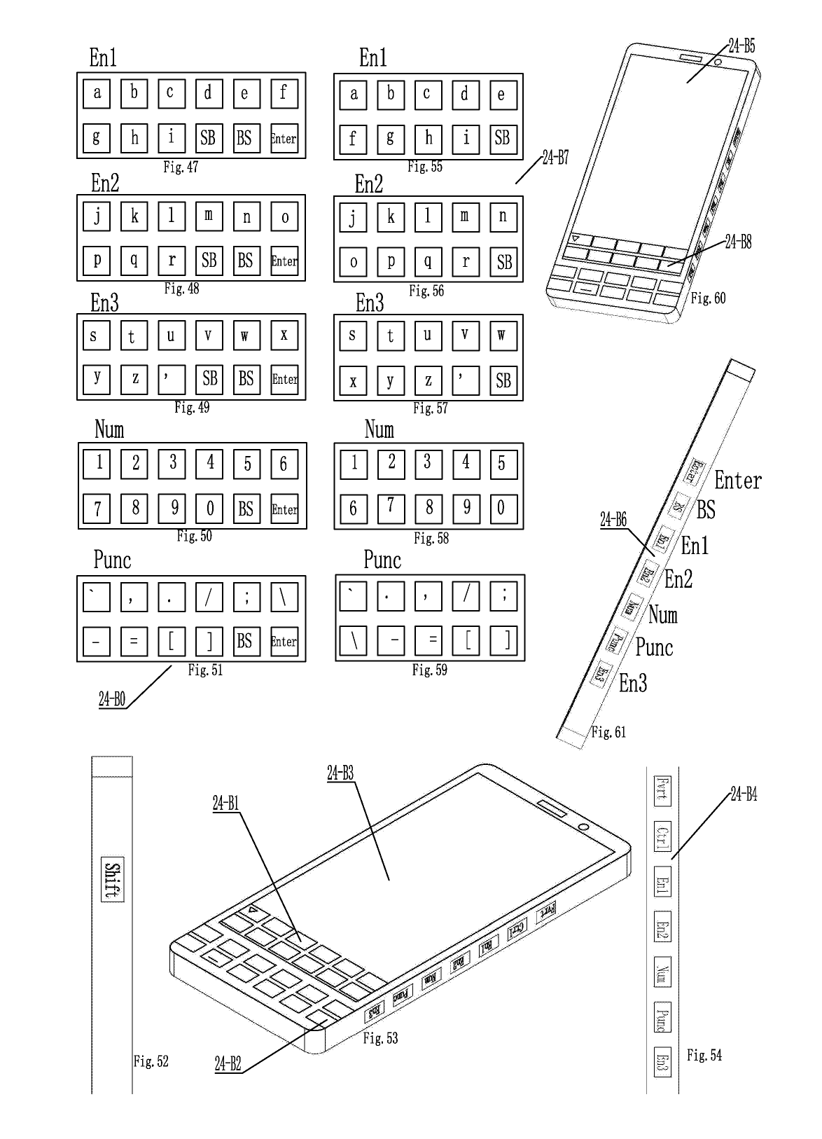

(3) 24-B3 in FIG. 53 is a cellular phone applying a hard main keyboard with a 2*6 matrix. The given 5 main keyboard layouts 24-B0, i.e., FIG. 47-51 correspond to side-keys: En1, En2, En3, Num and Punc respectively. Seven side-keys 24-B4: Fvrt, Ctrl, En1, En2, Num, Punc and En3 are configured on the right side and Shift key is configured on the left side. 24-B2 is a physical hard main keyboard with a 2*6 matrix. 24-B1 is a character dynamically-mapping zone on the touch display screen of the cellular phone, which can also be a soft touch keyboard at the same time. A character dynamically-mapping zone is necessary when a key of a hard main keyboard are unable to be tagged with all of the corresponding characters/symbols.

24-A6 in FIG. 46 is another side-key layout for cellular phone 24-B3 in FIG. 53. If the cellular phone is a little large in size, or Alt key is included to make the total side-keys on the right side to reach 8 keys shown as 24-A9 in FIG. 46, the fore and little fingers of the left hand maybe cannot reach some corresponding side-keys or at least cannot touch/press them comfortably. In order to make the fingers of the left hand to be able to operate the side-keys easily yet, the side-keys extend backwards onto the back and are distributed in an arc as 24-A8 in FIG. 46. If the side-keys is of a touch pad/screen, the phone should detect the currently pressed/touched side-key in accordance with the arc principle. En1 is the default key pressed/touched by the fore finger of the left hand and Punc is the default key pressed/touched by the little finger of the left hand. Ctrl and Fvrt are operated by the fore finger of the left hand moving upwards. En3 and Alt are operated by the little finger of the left hand moving downwards. When one of Ctrl, Alt and Fvrt is pressed/touched, En1 is pressed/touched by default. When Alt is released and Punc is pressed/touched at the same time, En1 is pressed/touched by default. After Fvrt is pressed/touched, it is released at once. The relations between the side-keys of the other side-key layouts can be referred to these principles.

24-B5 in FIG. 60 is a cellular phone applying a hard main keyboard with a 2*5 matrix. The given 5 main keyboard layouts 24-B7, i.e., FIGS. 55-59 correspond to side-keys: En1, En2, En3, Num and Punc respectively. Seven side-keys 24-B6: Enter, BS(short for Back Space), En1, En2, Num, Punc and En3 are configured on the right side and Shift key is configured on the left side. When releasing Enter or BS, the fore finger of the left hand returns to En1, the currently pressed side-key do not change. Because the Fvrt key is not configured, a input language switch button, for example, between Chinese and English, should be configured at a proper positon on or near character dynamically-mapping zone 24-B8. In this side-key layout, Ctrl and Alt are also not configured because of no enough space.

(4) 24-C6 in FIG. 67 is a cellular phone applying a hard main keyboard with a 2*6 matrix which layouts have extension keys. 24-C1, 24-C3, 24-C4 and 24-C5 are only part of main keyboard layouts which are mapped onto character dynamically-mapping zone 24-C7 dynamically depending on the currently touched/pressed side-key(s). They correspond respectively to side-keys: En1, En2, Num, Punc. The number \textcircled{2} 24-C2 means that this row is an extension key row in which each extension key is realized by the corresponding 2 keys of the hard main keyboard pressed and released at the same time. For example, the extension key “Enter” is realized by “d” and “e” keys of the hard main keyboard pressed and released at the same time. Button 24-C9 is used to close the character dynamically-mapping zone. The phone should be able to remember the opening and closing state of the zone. A system setting option can also be provided to the user to set the opening and closing state of the zone. Hard main keyboard 24-C8 is with a 2*6 matrix. The side-key layout is the same as the one of the 4*4 matrix solution of FIGS. 35-37.

24-C11 in FIG. 71 is a cellular phone applying a hard main keyboard with a 2*5 matrix which layouts have extension keys. 24-C14 and 24-C16 are part of the main keyboard layouts, corresponding respectively to side-keys: En1 and En2. The side-key layout is the same as the one of the above 24-C6 in FIG. 67.

(5) 24-E7 in FIG. 77 is a cellular phone applying a hard main keyboard with a 1*6 matrix which layouts have extension keys. 24-E1, 24-E4, 24-E5 and 24-E6 are part of the main keyboard layouts and correspond respectively to side-keys: En1, En2, Num and Punc. The side-key layout is the same as the one of the 4*4 matrix solution of FIGS. 35-37. The number \textcircled{4} 24-E2 in FIG. 72 means that this row is an extension key row in which each extension key is realized by the corresponding 4 keys of the hard main keyboard pressed and released at the same time. For example, the extension key “SB(short for Space Bar)” is realized by “b”, “c”, “d” and “e” keys of the hard main keyboard pressed and released at the same time. The slash “/” 24-E3 means that this row is an extension key row in which each extension key is realized by the corresponding key of the hard main keyboard together with auxiliary key 24-E10 pressed/touched and released at the same time. For example, the extension key “y” is realized by the “s” key of the hard main keyboard together with auxiliary key 24-E10 pressed/touched and released at the same time. Auxiliary key 24-E10 had better be realized by a touch key which comprises two part: part A which is on the front surface and near the first key of the main keyboard and part B which is at the corner side. Of course, the auxiliary key can comprise only part A like 24-E14 in FIG. 81.

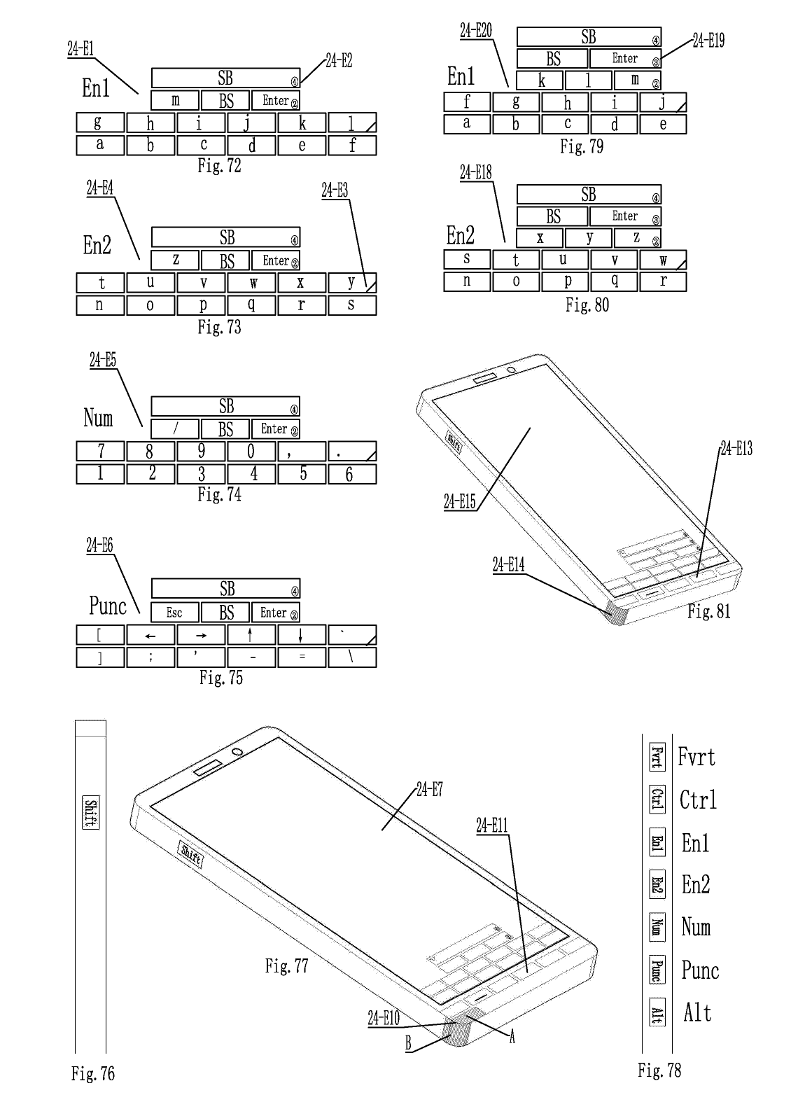

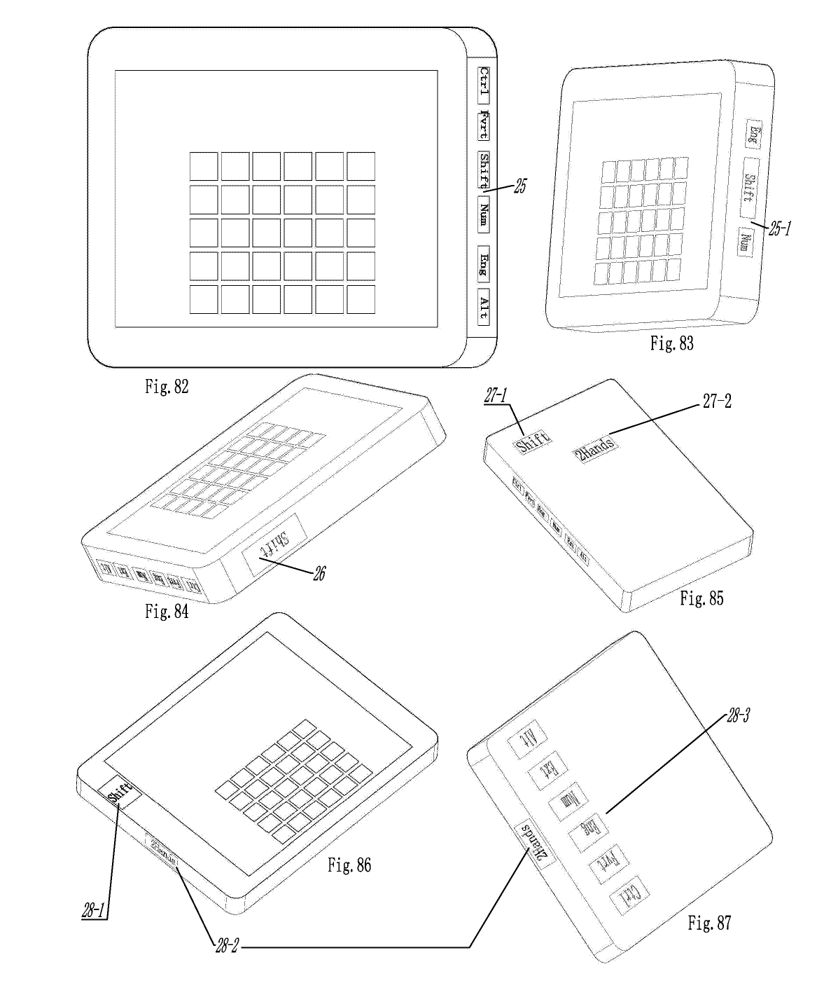

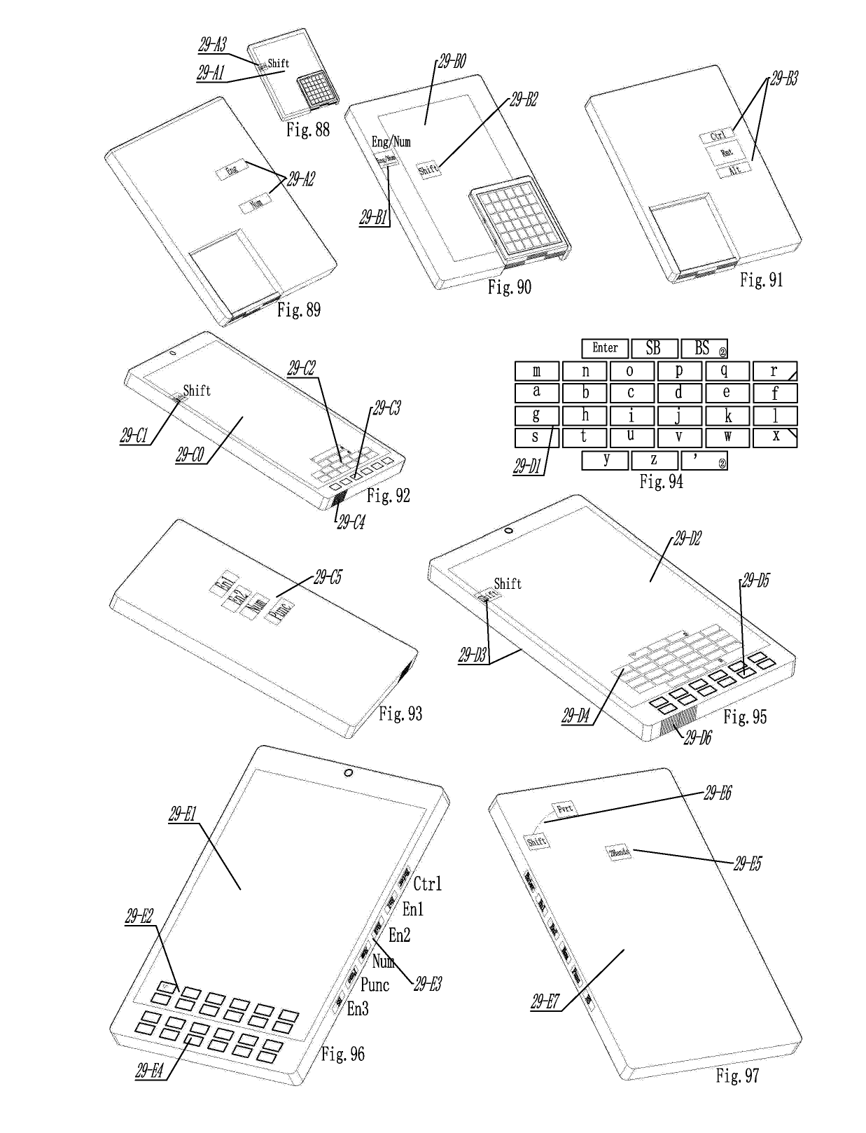

24-E15 in FIG. 81 is a cellular phone applying a hard main keyboard with a 1*5 matrix which layouts have extension keys. 24-E20 and 24-E18 are part of the main keyboard layouts and correspond respectively to side-keys: En1, En2. The side-key layout is the same as the one of the 4*4 matrix solution of FIGS. 35-37. The number \textcircled{3} 24-E19 in FIG. 79 means that this row is an extension key row in which each extension key is realized by the corresponding 3 keys of the hard main keyboard pressed and released at the same time. For example, the extension key “Enter” and “BS” are realized by “c”, “d”, “e” and “b”, “c”, “d” keys of the hard main keyboard pressed and released at the same time respectively. The above “\textcircled{2} \textcircled{3} \textcircled{4} /” marks for the extension key rows, of course, can be replaced by the other proper marks.

(6) 29-D2 in FIG. 95 is a tablet applying a hard main keyboard with a 2*6 matrix. The side-key layout 29-D3 is the same as the one of tablet 29-A1 in FIG. 88. 29-D1 in FIG. 94 is part of the main keyboard layouts and corresponds to the side-key Eng. 29-D4 is a character dynamically-mapping zone. 29-D5 is the hard main keyboard. Auxiliary key 29-D6 is at the left of the bottom side of the tablet and near the first key of the second row of the main keyboard. The auxiliary key is pressed/touched and released together a target key of the main keyboard at the same time, or pressed/touched before a target key of the main keyboard is pressed and released after the target key of the main keyboard is released like the Shift key of a PC keyboard, or is locked when pressed/touched in the first instance and unlocked when pressed/touched again like the Caps Lock key of a PC keyboard. Auxiliary key should be made wider for easy operation. Auxiliary key is either for all of the two rows of the main keyboard or only for the second row. The first key of the second row of the main keyboard can be reused as the auxiliary key of the first row if necessary, however, the reused first key of the second row cannot be operated like the Caps Lock key of a PC keyboard because it must be used as a common keyboard key at the same time.

(7) Because cellular phones are small in size, if the end keys of each row of the main keyboard are made smaller as 6 in FIGS. 4 and 16-1 in FIG. 15, the middle keys of the main keyboard can be made larger to make the main keyboard to be used more easily. And moreover more keys at the ends of each row can be reduced as 16-2 to 16-14 in FIGS. 15 and 16-12 in FIG. 17, and the reduced keys can also be not the same size, for example, in 16-2, B is smaller than C and F which are smaller than D and E yet. 16-3 is the same as 16-2 except an additional G which is the same size as B. 16-4 is the same as 16-3 except an additional A which is smaller than B and G. In 16-2, 16-3 and 16-4, C is the default key pressed by the fore finger of the right hand. 16-5, 16-6, 16-7 and 16-8 are sectional views of 16-1, 16-2, 16-3 and 16-4 respectively. In 16-5, pA and pB near the edges of the two end keys correspond to the fingertips of the fore finger and little finger of the right hand. In 16-9, C and D are the same size, A and B are combined into a conjoined key which is smaller than two C/D keys, and E is smaller than C/D. 16-10 has two conjoined keys. In 16-9 and 16-10, B is the default key pressed by the fore finger of the right hand. In 16-12, C and F which are the same size are smaller than D and E which are the same size, A and B are the same size and smaller than C and F, the default key pressed by the fore finger of the right hand is C.

Except reducing the keys at the ends of each row of the main keyboard, we can also make full use of the space at the two borders of the main keyboard as 10-1 in FIGS. 6 and 24-B2 in FIG. 53.

(d) Compatible with QWERT layout. There are 3 kinds of English letter main keyboard layouts. 13 in FIG. 11 is a 5*6 matrix alphabetical layout. 20 in FIG. 23 is a 5*6 matrix layout imitating a PC keyboard QWERT layout. 21 in FIG. 24 is a 5*6 matrix layout imitating a PC keyboard QWERT layout. These provide conveniences to users who are used to a PC keyboard QWERT layout. In the case of a soft main keyboard, if a system setting option is provided, a user can select one of the above layouts to use conveniently. In order to unify the standard, it is recommended that a main keyboard had better employ the English letter alphabetical layouts as 13 in FIGS. 11 and 14 in FIG. 12.

(B) Side-keys. (a) Kinds of side-keys. The side-keys can be either conventional physical hard keys, or touch-control soft keys, or even of a touch pad/touch screen/touch display screen with multi-touch function as 30-3 in FIG. 98, 30-5 in FIGS. 99, 31-2 and 31-4 in FIG. 101 (The touch pad is taken as example to describe below). The dashed-line boxes of 30-5 in FIGS. 99 and 31-2 in FIG. 101 are only for illustration and don't exist on the tablet back in reality. The advantages of the touch pad side-keys are that the side-keys need not be tagged and the user need not position his/her fingers accurately. The specific locations of the side-keys on the touch pad are determined by the specific touch positions of the fingers holding the touch pad together with the handheld digital device when the side-keys are activated. In order to avoid cumulative operation error, the locations of the side-keys on the touch pad should be adjusted dynamically at intervals or each time when an operation takes place. In the case of the touch pad side-keys, a handheld digital device can determine the currently active side-key by the currently acting finger which is determined by the OS or a special software according to the principle that the relative positions of one hand's fingers are certain, i.e. that the sequential relationship of the five fingers of one's hand won't change no matter how the holding position of one's hand changes. If the main keyboard is a soft keyboard without fixed position and direction, and the side-keys is of a touch pad, one set of side-keys can be in common use between a lefty and a righty with the aid of the attitude sensor(s) of the handheld digital device. Because we can tell whether the user is a righty or a lefty and furthermore tell the correct side-key corresponding to the currently active finger according to whether the position of the user's hand holding the device and the touch pad is at the right or at the left when the device attitude is certain. In the case of a soft main keyboard, even though the side-keys are not of a touch pad but hard or soft keys, it can also be in common use between a lefty and a righty with the aid of the attitude sensor(s) of the device, but we can't tag the side-keys, because the specific spatial order of the same set of side-keys are just inverse between a lefty and a righty. Of course in advanced applications, we can tag the side-keys dynamically with the aid of the attitude sensor(s), i.e. each side-key displays its key name dynamically and independently. A plurality of physical marks should be marked on part or all of the side-keys to facilitate the user to position his/her fingers as 2-1 in FIG. 3, 24-10A in FIGS. 37 and 24-A5 in FIG. 45. A touch pad is the best way to realize the side-keys. The side-keys can also be extended to the back of a handheld digital device properly as 8-1 in FIG. 5, 31-5 in FIGS. 101 and 24-A8 in FIG. 46.

(b) Variability of side-keys' positions. The Shift key has various possible positions. It can be located on the left side of a cellular phone as 3 in FIG. 1, or at the left of the top side of a cellular phone as 9 in FIG. 5, or on the right side and incorporated into the other side-keys as 25 in FIG. 82, or at the right of the top side of a tablet as 26 in FIG. 84, or on the back of a tablet as 27-1 in FIG. 85, or at the upper left corner of a tablet front surface as 28-1 in FIG. 86. The Shift key is operated by the mid-finger of the user's left hand when it is incorporated into the other side-keys on the right side of a device as 25 in FIG. 82, and by the thumb of the user's left hand when it is at/on the other positions. The 2Hands key can be located on the left side as 3 in FIG. 1, 28-2 in FIG. 87, or on the back of a tablet as 27-2 in FIG. 85. The 2Hands key is pressed/touched naturally by the root bulge of the thumb of the user's left hand when a device is held by the user's left hand. The 2Hands key is not a key with a strong function, and is generally used to direct a device to start initializing for enabling the solution and disabling the other solution (if the solution and the other solution(s), for example, a soft QWERT keyboard, coexist with a device). The 2Hands key generally need not be configured. The other side-keys have also various possible positions such as the right side as 4 in FIG. 3, the left side 31-4 in FIG. 101, or the back of a tablet as 28-3 in FIG. 87, or the outside of a hard keyboard as 48-3 in FIG. 111.

(c) Variability of side-keys' number. How many languages or characters can be inputted at the same time are determined by the number of the side-keys. 8 side-keys are configured in FIG. 1 and FIG. 3, the Shift and 2Hands keys are on the left side of the cellular phone and the other 6 side-keys: Ctrl, Fvrt, Eng, Num, Ext and Alt are on the right side. In soft keyboard bar phone 5 in FIG. 4, five side-keys are configured, the Shift key is at the left of the top side of the phone and the other 4 side-keys: Ctrl, Eng, Num and Alt are on the right side of the phone. In cellular phone 24-A6 in FIG. 46, the Shift key is configured on the left side and 8 side-keys: Fvrt, Ctrl, En1, Ent, Num, Punc, En3 and Alt are configured on the right side. Only three side-keys: Shift, Eng and Num are configured on the left and right sides of the cellular phone as 12-1 in FIGS. 9 and 12-2 in FIG. 10. The number of side-keys specific to a device should be determined flexibly.

(d) Best layout of side-keys. It differs from phones to tablets. The best side-key layout of a phone is the eight-key layout as shown in FIG. 1 and FIG. 3. The best side-key layout of a tablet is the six-key layout as 25 in FIG. 82, wherein all the side-keys including the Shift key are incorporated onto the same side. Considering the usage compatibility between phones and tablets, the 6 side-key layout on which all the side-keys are incorporated onto the same side as 25 in FIG. 82 is preferred to be used as the standard side-key layout, wherein the order of the side-keys is Ctrl, Fvrt, Shift, Num, Eng, Alt. This standard side-key layout can provide at least 30*3*2=180 kinds of possible inputs more than about 100 kinds of inputs of a PC keyboard. When a cellular phone uses the 6 side-key layout as 25 in FIG. 82, an Ext/Rmt(short for Remote) key can also be configured at the upper of the left side i.e. the original location of the Shift key(please refer to 3 in FIGS. 1, and 4 in FIG. 3). Besides, there are some special and more practical side-key layouts as below:

(1) In FIG. 88, 29-A1 is a flip hard keyboard tablet with narrow frame. Shift 29-A3 is configured at the upper left corner of the tablet front surface, and only two side-keys: Eng and Num as 29-A2 are configured at the left of the tablet back. Eng and Num are operated respectively by the fore and little fingers of the left hand. The space are blank between Eng and Num, i.e. the middle and ring fingers are not used. Shift key 29-A3 is cross the edge of the touch display screen and shields the interface elements of the touch display screen under it. The back side-keys should be realized by a touch pad/screen, and the side-key boxes and names as 29-A2 need not exist actually because the locations of the side-keys on a touch pad/screen change each time when a device is held and activated anew.

(2) 29-B0 in FIG. 90 is a flip hard keyboard tablet with wide frame, which is able to be used as a handheld keyboard with remote function. Two side keys: Eng/Num(a toggling key) 29-B1 and Shift 29-B2 are configured at the upper left corner of the tablet front surface, and three side-keys: Ctrl, Rmt(short for remote) and Alt as 29-B3 are configured at the left of the tablet back. Ctrl and Alt are operated respectively by the fore and little fingers of the left hand. Rmt are operated by the middle finger and/or the ring finger. Rmt key is twice larger than any of Ctrl and Alt and occupies a space of two side-keys. This side-key layout is easier for the user to operate. Eng/Num side-key 29-B1 had better be a touch key. It should be marked physically to facilitate the user to position the thumb because the thumb have to operate another side-key: Shift. Shift is a side-key on the touch display screen and shields the interface elements under it. Shift should allow the user to move to a favorable position to operate. The tablet should remember the last Shift position. Shift is displayed and enabled only in edit, shortcut and simulated mouse modes. Shift should be defined larger for easy operation.

(3) 29-C0 in FIG. 92 is a narrow frame tablet with a 1 row *6 columns matrix hard main keyboard. Shift 29-C1 is configured at the upper left corner of the tablet front surface. Four side-keys En1, En2, Num and Punc as 29-C5 are configured at the left of the tablet back. The side-keys on the back should be distributed in an arc as 29-C5 or longer because every fingers are not the same length. 29-C2 is a character dynamically-mapping zone. 29-C3 is a hard main keyboard with 1*6 key matrix. 29-C4 is an auxiliary key which should be marked physically. Please refer to cellular phone 24-E7 in FIG. 77 and the main keyboard matrix section of this description for more details.

(4) 29-E1 in FIG. 96 is a narrow frame tablet with a 2 *6 matrix hard main keyboard. 6 side-keys Ctrl, En1, En2, Num, Punc, En3 as 29-E3 are configured on the right side of the tablet. Three side-keys: Shift, Fvrt and 2Hands as 29-E6 and 29-E5 are configured at the right of the tablet back 29-E7. Shift and Fvrt are distributed in an arc about the point: 2Hands and operated by the thumb of the left hand. The dashed line arc is only for illustration. Shift is near the right side of the tablet and is the default key operated by the thumb, and Fvrt is near the top side and operated by the thumb moving upwards and leftwards. 2Hands is pressed/touched by the root bulge of the thumb when the tablet is held by the left hand at the right. 29-E4 is a 2*6 matrix hard main keyboard. 29-E2 is a character dynamically-mapping zone. Please refer to cellular phone 24-B3 in FIG. 53 and the main keyboard matrix section of this description for more details.

(5) In FIG. 83, three side-keys: Eng, Shift and Num as 25-1 are configured on the right side of the tablet. Eng and Num are operated by the fore finger and little finger of the left hand respectively. Shift is operated by the middle finger and/or the ring finger. Shift is twice larger than any of Eng and Num and occupies a space of two side-keys. The Shift key can also be put at the right of the tablet back and the space between Eng and Num is leaved blank and used to put the middle and ring fingers of the left hand.

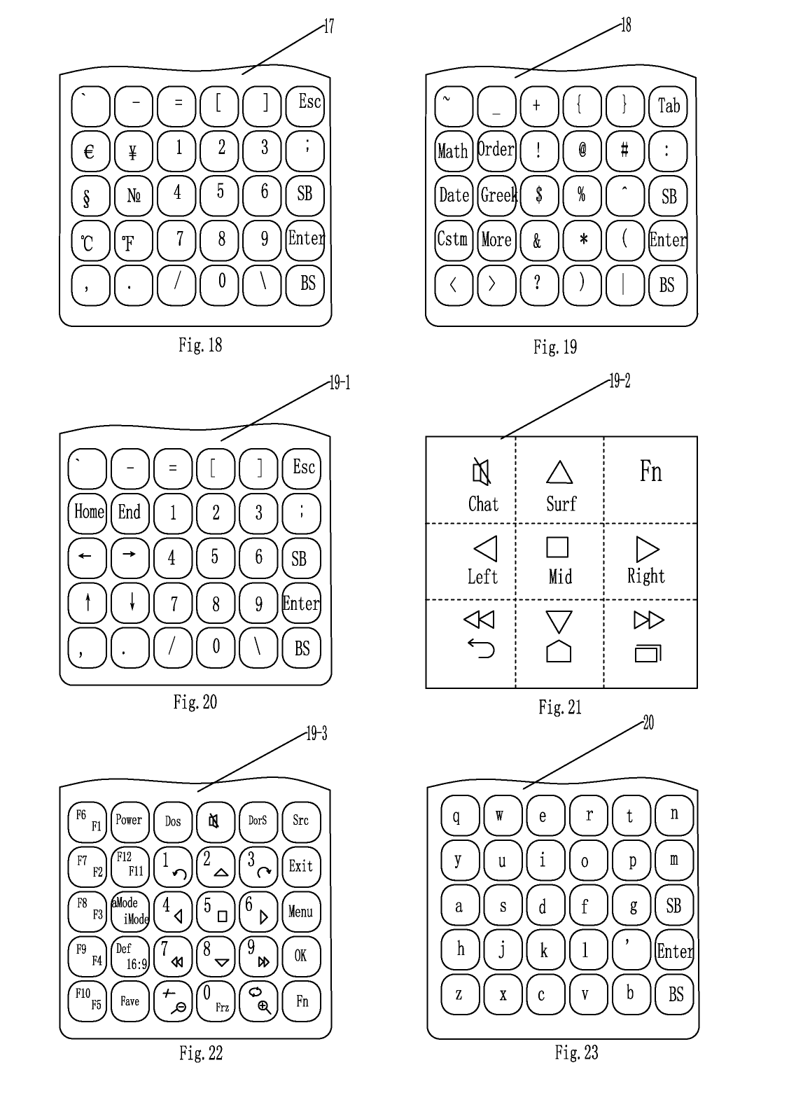

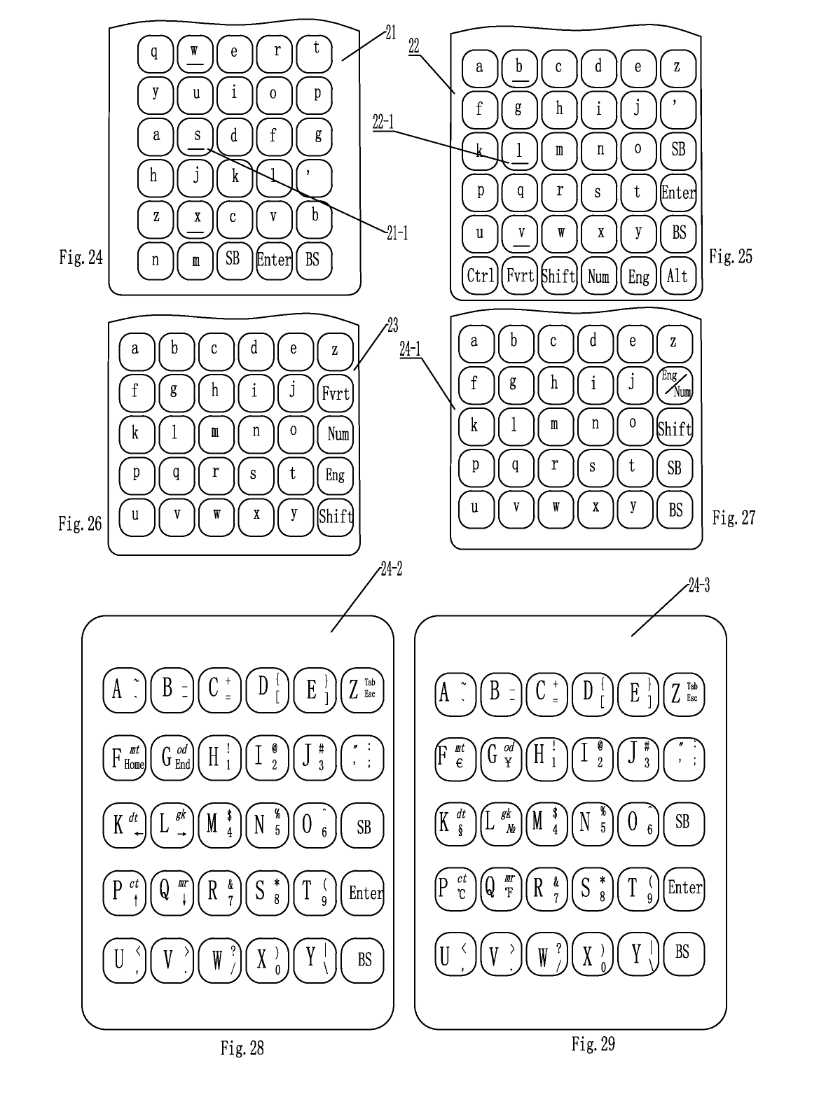

(6) In FIGS. 9-10, three side keys: Shift 12-1, Eng and Num 12-2 are configured on the left and right sides of the cellular phone respectively. Shift is operated by the thumb of the left hand, Eng and Num are operated by the fore and little fingers of the left hand respectively. The space between Eng and Num is blank and used to put the middle and ring fingers.

(7) The simplest and easiest side-key layouts are Shift-Eng-Num side-key layouts as 12-1 and 12-2 in FIGS. 9-10, 29-A3 and 29-A2 in FIGS. 88-89, 25-1 in FIG. 83, but the functions of the keyboards are limited. At the same time, Shift, Eng and Num can be reused as the left, right and middle simulated mouse buttons.

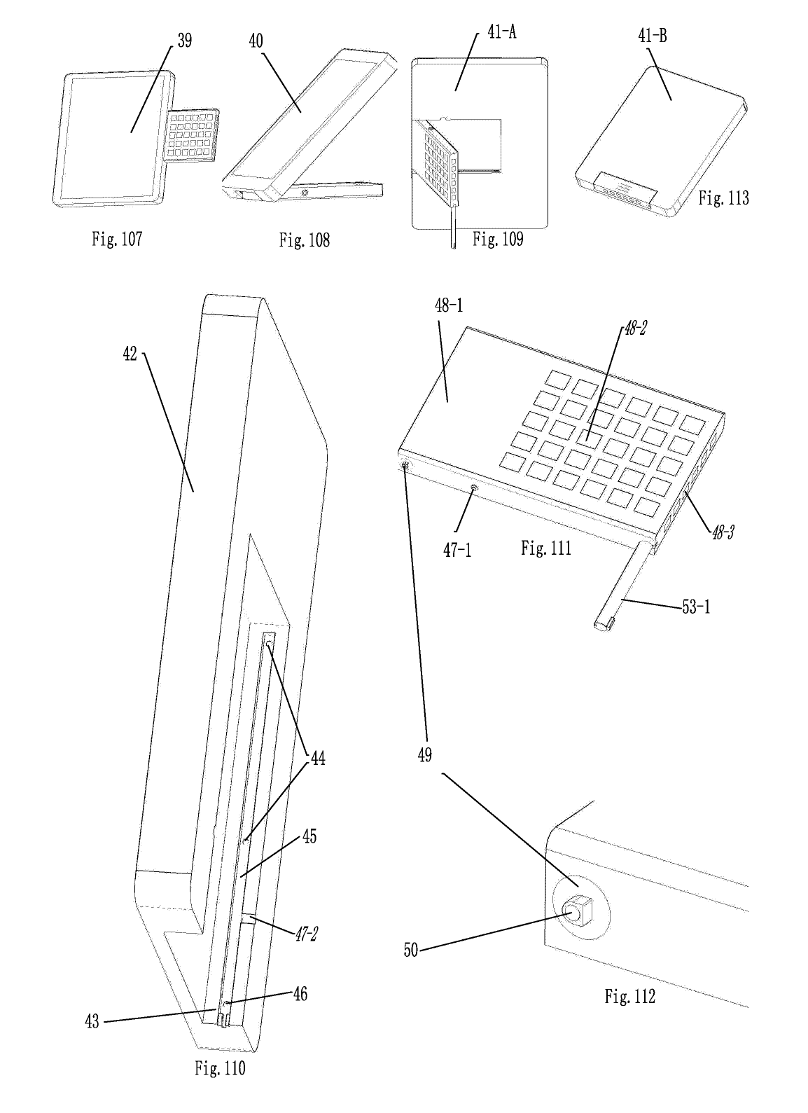

(8) 31-6 in FIGS. 102-103, 31-7 in FIGS. 104-105 and 31-8 in FIG. 106 are side-key layouts applicable to handheld digital devices able to be used as handheld keyboards with remote function.

(e) Sets of side-keys. More than one set of side-keys can be configured. In this case, the Shift key is generally incorporated with the other side-keys on the same side and 2Hands is not configured. Particularly a tablet has two holding attitudes: longitudinal and transverse holding attitudes, and moreover each holding attitude has two holding positions such as the right side and the left side shown in FIG. 82 and FIG. 86. The tablet shown as 30-1 in FIGS. 98 and 30-4 in FIG. 99 is configured with 2 sets of side-keys respectively on the right side and at the left of the back to facilitate the user to change the holding gesture and position. Considering that a device is in common use between a lefty and a righty, more sets of side-keys can be configured. The tablet shown as 31-1 in FIGS. 100 and 31-3 in FIG. 101 is configured with 4 sets of side-keys only in a longitudinal holding attitude. They are the 2 touch pads on the right side and at the left of the back for a righty, and the other 2 touch pads on the left side and at the right of the back for a lefty, and they disable each other, i.e. one of them is enabled, the other three are disabled to avoid confusion. 79-1 in FIG. 140 is a double face handheld keyboard, 2 sets of side-keys as 79-2 and 79-3 are configured on the left and right sides, which respectively correspond to the front keyboard and the back touch pad. If a lefty button is configured as 79-5, the double face handheld keyboard is easy to be in common use between a lefty and righty. No matter whether one set or multiple sets of side-keys is/are configured, each set of side-keys should be distributed reasonably to allow the fingers of one hand of the user to both hold the handheld digital device and operate the side keys conveniently and comfortably. A handheld digital device should use one set of side-keys except a double face handheld keyboard as 79-1 in FIG. 140.

(f) Avoiding mis-operation of side-keys. For example, the side-keys on the right side should have been held and operated by the left hand, but they are actually held by the right hand of the user. But in this case, only the palm of the right hand contacts the right side, so it is difficult to produce 4 contact points at the same time at the beginning of holding (generally 2 contact points). So no matter whether the side-keys are hard keys or soft keys or even of a touch pad, according to this feature, we can determine whether the holding gesture of the side-keys is correct or not, and furthermore determine whether to enable the side-keys and the default main keyboard layout. Of course, we can also avoid mis-operation completely by configuring a 2Hands key.

(g) Pressing/touching methods of side-keys. The most difficult technical problem of the solution is that the left hand not only holds the handheld digital device, but also must perform the pressing/touching actions of the side-keys at the same time, and moreover except Ctrl, Alt, and the Shift key on the top side of the device etc., some of the side-keys are usually held or pressed/touched by the fingers of the left hand. It is very important how to distinguish the user's inputting presses/ touches of the side-keys from his/her holding presses/touches of the side-keys. For the side-keys which are usually held, in other words, touched/pressed by fingers, there are 2 preferred pressing/touching methods as below: a) releasing the finger corresponding to a target side-key in the first instance, and then at once pressing /touching back, and b) pressing or touching a target side-key by the corresponding finger with a larger force in the first instance, and then relaxing the finger into a naturally holding or pressing/touching state at once.

(h) Activation and deactivation of side-keys. The side-keys are activated when Fvrt, Shift, Num and Eng all are pressed/touched at the same time (Taking side-key layout 25 in FIG. 82 as an example), and the main keyboard enables the layout corresponding to Fvrt or Eng. The side-keys are deactivated when all the side-keys are released after their activation. The main keyboard can be used for the other purposes when the side-keys are not enabled. After the side-keys are enabled, when the device is not in edit mode or there is not any simulated mouse action, some of the side-keys can be used for the other purposes such as Home, Back, Forward, Recent, Menu, Vol+ and Vol-keys etc. (In a simulated mouse interface, the side-key reused as the middle simulated mouse button is not suitable for being used for the other purpose). In order to prompt the user which side-key(s) is/are touched/pressed currently, a plurality of indicators or indicator lights can be configured at the proper locations of a display screen or a hard main keyboard as 8-2 in FIGS. 4 and 75-6 in FIG. 137. The indicators or indicator lights are displayed or enabled when the side-keys are activated, and are hided or disabled when the side-keys are deactivated, i.e. any mis-operation on the side-keys is not indicated.

(C) One-hand keyboard. The side-keys can be incorporated into the main keyboard too. 22 in FIG. 25, 23 in FIGS. 26 and 24-1 in FIG. 27 are 3 examples of one-hand keyboard layouts. In these cases, when a side-key is pressed/touched, it should be highlighted or indicated by a light to avoid confusion. For example, assume that 22 in FIG. 25 is a soft one-hand keyboard, when it is enabled, Fvrt is highlighted; when Ctrl and/or Alt are pressed, they are highlighted, Eng is highlighted too and the other side-keys are dis-highlighted at the same time, and after a shortcut operation is completed, Ctrl and Alt are dis-highlighted and Fvrt is highlighted simultaneously. If the main keyboard has had any input operation, the highlight relations among Fvrt, Eng, Num are mutually exclusive, and if the main keyboard has not had any input operation since one of them is pressed/touched, the highlight relations among them is not mutually exclusive in order to realize joint presses of these side-keys. The Shift key is dis-highlighted when any other side-key is pressed/touched, and the continuous presses on the Shift key toggle the Shift key itself between highlight and dis-highlight and do not change the highlight status of the other side-keys. The missing SB(short for Space Bar), Enter, BS(short for Back Space) keys in layouts 23 and 24-1 are configured on the number and punctuation layout which is not illustrated to save space. This one-hand solution can also be combined with the above principal two-hand solution, so, when a device is held by a single hand, the one-hand keyboard is enabled and operated by a single hand, and when held by two hands, the left hand activates the side-keys and the right hand operates the main keyboard. A one-hand keyboard had better be a hard keyboard with a key matrix having 2/3/4/5/6 rows and 4/5/6/7 columns. The important distinction between a one-hand keyboard and a popular QWERT keyboard is: (a) the keys of each row of a one-hand keyboard is limited, 6 keys is preferred and 5, 4 even 7(especially when the keys at the ends of each row are reduced) keys is also applicable and optional, so a single key of a cellular phone can be made big enough. But the keys of each row of a QWERT keyboard can be up to 10 at most, so a single key of a cellular phone with a QWERT keyboard cannot be made big enough; (b) Although a single key of a tablet with a QWERT keyboard can be made big enough, but each row is too wide to fit for simultaneous operations by multiple fingers of one hand, because it is difficult for the user to position his/her fingers accurately on the wide keyboard layout. (c) No matter whether a device is a phone or a tablet, even if a QWERT keyboard is a hard one, it is not fit for touch typing at a high speed, but if a one-hand keyboard is a hard one, because it is fit for simultaneous operations by multiple fingers of one hand, so it is fit for touch-typing at a high speed too. (d) Even though a one-hand keyboard is operated by a single finger of a single hand, the hand-feel becomes much better. As a general rule, a two-hand keyboard solution but a one-hand keyboard solution is preferred. Of course, in order to adapt to a lot of application occasions, a main keyboard can also use a one-hand layout at the same time when a plurality of side-keys are configured.

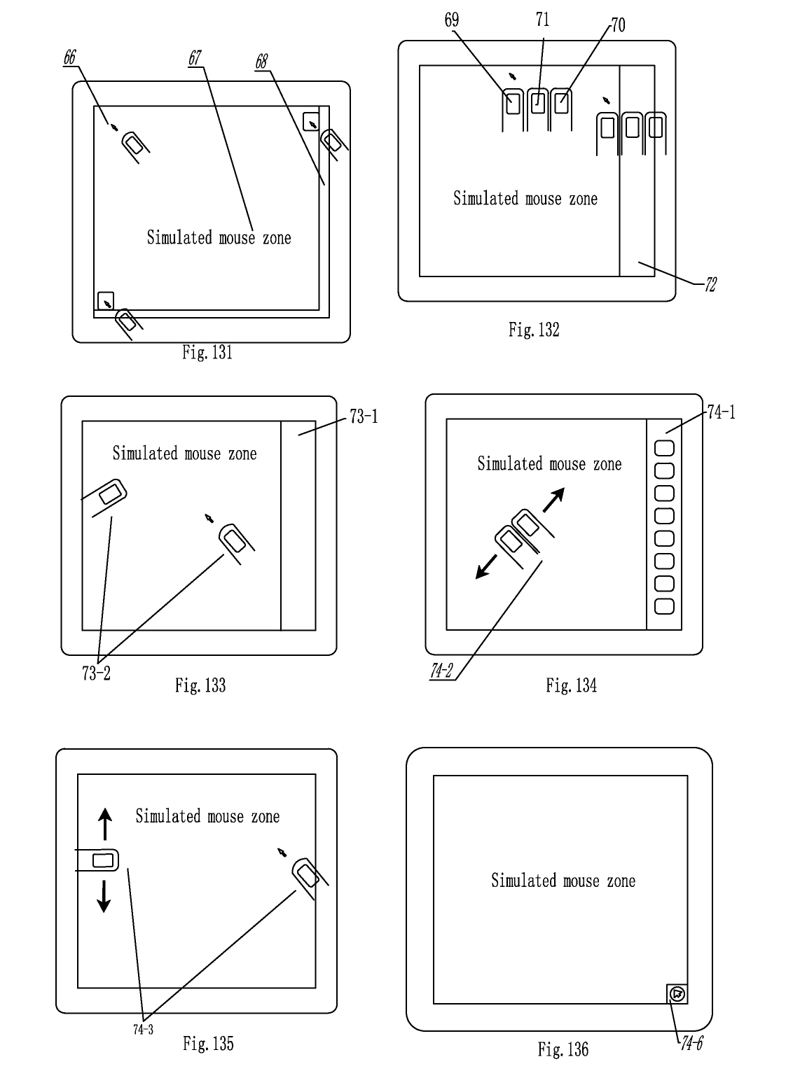

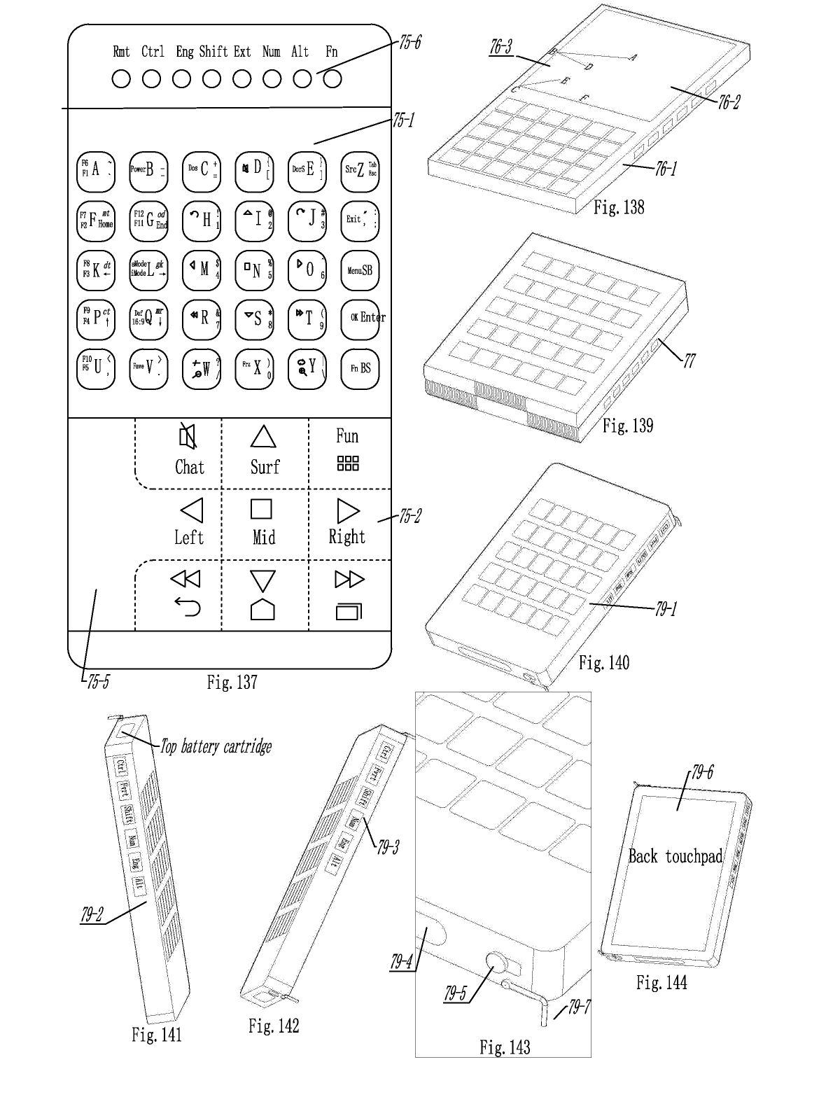

(D) Simulated mouse. There are three kinds of parallel solutions. (a) We can combine a screen-touching finger and a plurality of side-keys together to simulate a mouse. A forefinger, a mid-finger or another finger touching and/or sliding on a touch display screen can be served as a simulated mouse as 71 in FIG. 132. When the simulating finger touches on the touch display screen, the simulated mouse cursor appears at the upper left corner of the simulating finger as 66 in FIG. 131. When the finger leaves the touch display screen, the simulated mouse cursor hides temporarily to synchronize the user's feeling, this is a little different from a PC mouse. Taking side-key layout 25 in FIG. 82 as an example, if Num, Eng and Fvrt are redefined and reused respectively as the left, right and middle buttons of the simulated mouse, a complete simulated mouse solution is realized (the middle button function of the simulated mouse is enabled when pressing/touching Fvrt in the first instance, and the function is disabled when pressing/touching Fvrt again). Here Num, Eng and Fvrt can also be written as NumL(left), EngR(right) and FvrtM(middle). Although the side-keys are redefined and reused, because it is impossible for the keyboard operation and the simulated mouse operation are performed simultaneously, so the confusions of the two kinds of operations won't take place. The relative position between the simulated mouse cursor and the simulating finger is constant. When the simulating finger moves at the right and the bottom of the touch display screen, there will be a simulated mouse dead zone which is about half a finger wide and on which we cannot simulate a mouse as 68 in FIG. 131. (b) In order to be able to simulate a mouse without the aid of the side-keys, we can take advantage of multi-touch technology to use the fingers clicking on the touch display screen at the left and the right of the simulating finger respectively as the left mouse button as 69 and right mouse button as 70(the fingers simulating the mouse buttons can also be the ones of the other hand as 73-2). The essence is that whether a simulated mouse click is a left click or a right click is determined by whether the touch point of the finger simulating a mouse button is at the left or the right of the finger simulating the mouse. And moreover if two fingers (for example fore-finger and mid-finger) sliding side by side on the touch display screen are defined and used as the middle simulated mouse button as 74-2, a mouse can be simulated completely only by fingers. A middle simulated mouse button can also be simulated by one finger touching and sliding together with another finger touching and staying on the touch display screen, of course, these two fingers can respectively belong to two hands as 74-3. The latter method simulating a middle mouse button should be distinguished from the method which zooms a user interface in and out by pinching two fingers out and in. When simulating a mouse only by fingers and without the aid of side-keys, a right simulated mouse button dead zone which is about one and a half fingers wide will be there as 72 in FIG. 132(if the mouse buttons are simulated only by side-keys, there will not be this zone). Taking account of the simulated mouse dead zone and the right simulated mouse button dead zone together, there are two zones at the right and the bottom of the touch display screen which are not fit for simulating a mouse. The bottom zone can generally be ignored because it is small. The right zone is only fit for the common touch operations (This zone can also be ignored because of smallness if the mouse buttons are simulated only by side-keys), which can be used as a toolbar zone using common touch operations as 74-1 in FIG. 134, or an auxiliary zone without any user interface elements as 73-1 in FIG. 133, or a static display zone incorporated into the simulated mouse zone at the left. (c) In the case of a device with a touch pen, the touch pen can be used to simulate a mouse with the aid of side-keys or fingers. When the mouse is simulated by a touch pen, the position of the pen point is the position of the simulated mouse cursor. Because the common touch operations on a touch display screen have obvious advantages in some applications and operations, so the simulated mouse solution of this invention cannot replace the common touch operations completely. Whether a user interface employs a simulated mouse interface, or a common touch operation interface, or a combination of the above two interfaces should be determined by a specific application. In general, an edit area or a work area is fit for a simulated mouse interface as 67 in FIG. 131, and a toolbar area is fit for a common touch operation interface. An interface toggle button can also be configured as 74-6, so the user can toggle the interfaces at any time according to his/her usage and operation requirement. In this way, an application can be changed dynamically between a simulated mouse interface and a common touch operation interface. The interface toggling can also be done automatically depending on whether the user holds the device by a single hand or by two hands. The above simulated mouse solution on a touch display screen can also be applied on a mouse touch pad, but the mouse touch pad has not the simulated mouse dead zone and need not hide the mouse cursor too.

(E) Usage of keyboard. Taking a tablet as 25 in FIG. 82 as an example, the main keyboard is a soft one on the touch display screen, and employs a 5*6 key matrix, and can be slidden on the screen according to the user's requirement. The main keyboard has 6 keys each row, wherein the 4 keys in the middle are operated respectively by the forefinger, mid-finger, ring finger and little finger of the right hand. The first key at the left end of each row is operated by the forefinger of the right hand moving to the left, and the final key at the right end of each row is operated by the little finger of the right hand moving to the right. The side-keys are configured with 6 keys: Ctrl, Fvrt, Shift, Num, Eng and Alt, which are located on the right side of the tablet. Fvrt, Shift, Num and Eng are operated respectively by the forefinger, mid finger, ring finger and little finger of the left hand. Ctrl is operated by the forefinger of the left hand moving upward, and Alt is operated by the little finger of the left hand moving downward. Wherein Num, Eng and Fvrt respectively correspond to the left, right and middle buttons of the simulated mouse too in order to cooperate with a user interface which has a simulated mouse function. The mother tongue is Chinese. When the user interface comes into edit mode, or the user presses Ctrl, Alt etc., the main keyboard appears. And when edit ends, or the user touches on non-edit area, or the user completes a shortcut operation, or the user presses Alt+Fvrt+BS at the same time, the main keyboard hides.

(a) When Fvrt is pressed, Chinese Pinyin layout 13 in FIG. 11 displays on the main keyboard to allow the user to input Chinese Pinyin (this layout also displays as soon as the main keyboard is enabled). (b) And then if Shift is pressed, Chinese punctuation layout 15 in FIG. 13 displays to allow the user to input Chinese punctuations. At this time, if the More key in layout 15 is pressed(if there is a More key in a layout, pressing Shift is also equivalent to pressing the More key, of course, the More key must be in a layout corresponding to a Shift+some side-key), Chinese punctuation extension layout 16 in FIG. 14 displays. If the Back key is pressed after completing the input operations with layout 16, the layout 16 returns to the last layout 15. If characters, symbols etc. in nested sub layouts are mutually exclusive, i.e. at most only one character, symbol etc. in the same layout is inputted at a time, as soon as the user completes an input operation, the layout returns to the last one at once without pressing Back. In addition, if a side-key is pressed after a nested sub layout displays, the current nested sub layout is changed to the layout corresponding to the pressed side-key(s) at once. (c) When Eng is pressed, Fvrt and Shift are restored to be in released status automatically (when one of Fvrt, Eng and Num is pressed, the other two side-keys and Shift are restored to be in released status automatically if the main keyboard has had any input action before. But when the input method of the Fvrt language displays a candidate word table indexed with numbers, and when Num key is pressed/touched, the other side-key's state need not be changed, and after a number is inputted and a word is selected, Num key is released by itself automatically. The same as below), and English a-z layout 13 in FIG. 11 displays to allow the user to input English a-z letters. (d) When Eng+Shift are pressed, English A-Z layout 14 in FIG. 12 displays to allow the user to input. (e) When Num is pressed, number and English punctuation layout 17 in FIG. 18 displays to allow the user to input.

(f) When Num+Shift are pressed, layout 18 in FIG. 19 displays to allow the user to input. When the Math, Order, or Greek key is pressed in layout 18, the corresponding math symbol layout, ordinal number layout, or Greek letter layout displays to let the user to input, but these nested sub layouts are not illustrated and described for brevity. If the Date key is pressed in layout 18 in FIG. 19, a menu with various Chinese and foreign formats of current date displays to let the user to select and input, which includes a cancel menu item to let the user to give up and return. The More key in layout 18 provides a possibility for the OS or an input method to provide more languages and symbols to allow the user to input, so a menu pops up to let the user to select when the More key is pressed. The Cstm key in layout 18 provides a possibility for the device end user to customize the layouts corresponding to Cstm and Cstm+Shift. The device vendor or an input method developer should provide a method for the end user to customize the layouts. In general, what can be customized by the end user is in various forms such as characters, character strings, pictures, audio or video data blocks, or shortcut commands.

(g) When Ctrl and/or Alt are pressed, Fvrt, Num and Shift are in released status automatically, but Eng is in pressed status automatically (even though the Eng key is not pressed and/or touched practically by a finger at this moment), so English a-z layout displays by default to allow the user to input commands similarly to the shortcut function of a PC keyboard. And if they are combined together with Shift and the other side-keys, more shortcut layouts will display for input. All shortcut operations are the same no matter whether a device is in edit mode or not. (h) Inputs of full-width English letters, numbers and punctuations. (Fvrt+Eng), (Fvrt+Eng)+Shift, (Fvrt+Num), (Fvrt+Num)+Shift respectively correspond to full-width English a-z, A-Z, number and punctuation layouts. Wherein the round brackets mean that the two side-keys inside them must be pressed continuously, and the other side-keys and the keys on the main keyboard are not allowed to be pressed between the presses of them. (i) When a finger simulating a mouse acts on the simulated mouse zone of the touch display screen, left click, double clicks, right click, screen-scrolling operation and mouse hover etc. can be realized with the aids of Num, Eng, Fvrt. Of course, the mouse can also be simulated only by fingers or by a touch pen at the same time.

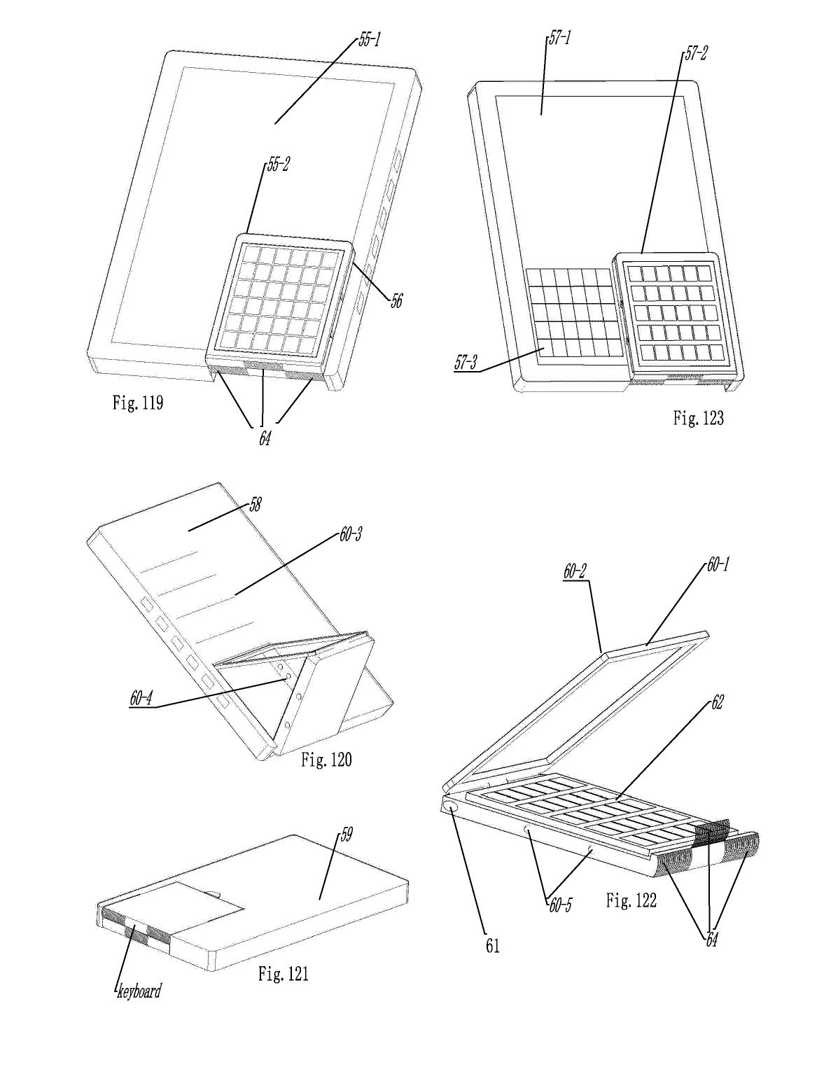

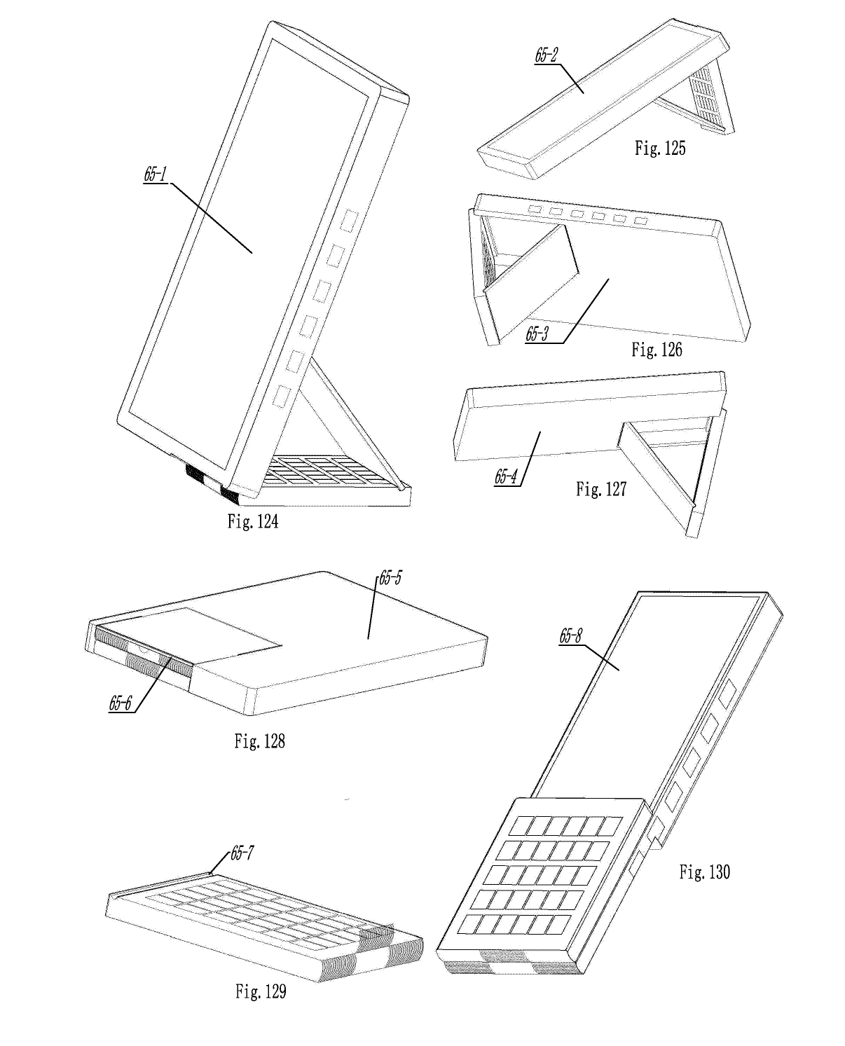

(F) Examples of cellular phones. Thirteen kinds of cellular phones applying the solution are given as below. (1) A bar phone with a soft keyboard on touch display screen is illustrated as 5 in FIG. 4. The Shift key is at the left of the top side of the phone as 9. The other 4 side-keys are Ctrl, Eng, Num and Alt on the right side of the phone as 8. This phone is fit for the users speaking English. In order to make a single key big enough, the end keys of each row are made smaller as 6. The finger positioning marks at the left and right borders of the phone are used for the user to position his/her fingers easily as 7. (2) A hard keyboard bar phone is illustrated as 10 in FIG. 6. The lower half is a hard keyboard, and the upper half is a touch display screen. (3) A slide phone is illustrated as 11 in FIG. 7. There are two sets of main keyboards: a soft one and a hard one. When the hard keyboard is not slidden out, the soft keyboard is used to input; when the hard keyboard is slidden out, the hard keyboard is used to input. The characters which are not tagged on the hard keyboard and which are on nested sub layouts enabled when More, Greek, Math, Order, Date or Cstm etc. is pressed, should be mapped onto the touch display screen (As long as a device is with a hard keyboard, the enabled relations of the hard keyboard and the soft keyboard, and the mapping of the nested sub layouts and the characters which are not tagged on the hard main keyboard are the same as the above no matter whether the device is a cellular phone or a tablet. The following will not repeat it). (4) A flip phone with a rotatable screen is illustrated as 12 in FIG. 8. Besides, (5) A flip phone with a single screen and (6) A flip phone with double screens are similar to a flip phone with a rotatable screen. (7) A flip hard keyboard phone is illustrated as 65-8 in FIG. 130, please refer to the section about flip hard keyboard tablet. (8) A foldable hard keyboard phone is as 53-4 in FIG. 118, please refer to the section about foldable hard keyboard tablet. (9) A cellular phone with a 4*4 matrix hard main keyboard as 24-9 in FIG. 36. (10) A cellular phone with a 3*5 matrix hard main keyboard as 24-A2 in FIG. 44. (11) A cellular phone with a 2*6 or 2*5 matrix hard main keyboard as 24-B3 in FIG. 53, 24-B5 in FIG. 60. (12) A cellular phone with a 2*6 or 2*5 matrix hard main keyboard with extension keys as 24-C6 in FIG. 67, 24-C11 in FIG. 71. (13) A cellular phone with a 1*6 or 1*5 matrix hard main keyboard with extension keys as 24-E7 in FIG. 77, 24-E15 in FIG. 81.

(G) Examples of tablets. (a) 25 in FIG. 82, 25-1 in FIG. 83, 26 in FIGS. 84 and 27-1 in FIG. 85 are 4 kinds of touch screen soft keyboard tablets which side-keys are mostly on the right side. \textcircled{1} Shift and Ctrl, Fvrt, Eng, Num, Alt are all integrated onto the right side of the tablet without Ext and 2Hands as 25. \textcircled{2} Shift 26 is at the right of the top side of the tablet, the other side-keys are on the right side which are the same as 4 in FIG. 3, and there is not a 2Hands key. \textcircled{3} Shift 27-1 in FIGS. 85 and 2Hands 27-2 are at the right of the back of the tablet, and the other side-keys are on the right side of the tablet which are the same as 4 in FIG. 3. \textcircled{4} Only three side-keys: Eng, Shift and Num are configured on the right side. (b) FIG. 86 is a touch screen soft keyboard tablet which side-keys are at the left side. Shift 28-1 is at the upper left corner of the tablet front surface, it can be either on the frame or on the touch display screen. 2Hands 28-2 is on the left side and the other side-keys 28-3 are at the left of the back of the tablet. (b-1) 29-C0 in FIG. 92 is a tablet with a hard main keyboard having a 1*6 key matrix with extension keys. (b-2) 29-D2 in FIG. 95 is a tablet with a hard main keyboard having a 2*6 key matrix with extension keys. (b-3) 29-E1 in FIG. 96 is a tablet with a hard main keyboard having a 2*6 key matrix. (c) 30-1 in FIGS. 98 and 30-4 in FIG. 99 are a hard keyboard tablet with two sets of side-keys which respectively are on the right side as 30-3 and at the left of the back of the tablet as 30-5. When one set of side-keys is enabled, the other set of side-keys is disabled to avoid confusion. The hard keyboard is able to be drawn out and pushed in like a drawer, and received into the keyboard room when not in use. This tablet provides 2 holding positions of side-keys. (d) 31-1 in FIGS. 100 and 31-3 in FIG. 101 are also a hard keyboard tablet, but it has 4 sets of side-keys which are respectively on the left side as 31-4, on the right side, at the left of the back of the tablet and at the right of the back of the tablet as 31-2. These 4 sets of side-keys also disable each other. This tablet solution is convenient for being common use between a lefty and a righty. The side-keys of the above 2 kinds of hard keyboard tablets in FIGS. 98 and 100 are realized by touch pads.

(e) Foldable hard keyboard tablets. 2 kinds of foldable hard keyboard tablets are illustrated as below. \textcircled{1} FIG. 107 and 113 are two foldable hard keyboard tablets. 41-A in FIGS. 109 and 41-B in FIG. 113 are the same, but 41-B is with a keyboard cover. Hard keyboard 48-1 in FIG. 111 is connected with tablet 42 in FIG. 110 by keyboard slide rods 47-1, keyboard axes 49 and keyboard guide-ways 45. Keyboard axis limit pits 50 are configured on the heads of keyboard axes 49. When these limit pits match and join with keyboard limit spring balls 44 (a half ball is on the top of a spring) in the keyboard guide-ways, the keyboard respectively is drawn out to be ready for input as 39 in FIG. 107 and received into the keyboard room as 41-B. The heads of keyboard axes 49 are of semi-square and semi-circle (The enlarged view of an axis is at the lower right corner as FIG. 112). When the two heads are slidden into keyboard axis limit notches 43, the axes are confined to the notches to be unable to pass through, but the heads of keyboard slide rods 47-1 are able to pass through because they are made thinner than the other parts of the rods. So when keyboard axis limit pits 50 match and join with keyboard axis limit spring balls 46, the keyboard can be folded backward to be used as a support of the tablet as 40. In order to get a larger freedom of inclination when the tablet is standing, keyboard slide rod gaps 47-2 are configured at the two sides of the keyboard room, which respectively correspond to keyboard slide rods 47-1 to allow the rods to pass through when the keyboard is folded. Of course the keyboard slide rod gaps can also be not configured in order to avoid unexpected drops of the keyboard from the gaps when the keyboard is drawn or pushed. A rotation constrain mechanism is configured between keyboard axes 49 and the keyboard, so the tablet is incapable of rotating freely under the effect of the weight of the tablet itself, but it can be rotated by the user with a larger force.

When touch pen 53-1 used as a support rod is drawn out and cooperates with the keyboard, the tablet can be put up in another orientation as 41-A. Of course the tablet can be put up in another orientation without the touch pen. The touch pen can also be used to simulate a mouse with the aids of side-keys and/or fingers besides it is used as a pen or a touch tool. The touch pen can be made as a scalable structure in order to adapt to the limited room receiving the touch pen in the hard keyboard. The limit pits in the touch pen as 53-3 in FIG. 114, cooperate with a limit spring ball inside the keyboard to be able to prevent the touch pen from sliding freely. Limit spring ball guide way 53-2 in the touch pen allow the touch pen to pass through the other part except the limit pits smoothly in order to avoid hard-going feel when the user draws and pushes the touch pen. Hard keyboard 48-1 in FIG. 111 is at the right side of the tablet and side-keys 48-3 are at the outer side of the hard keyboard and realized by a touch pad (if the layouts of the hard keyboard display dynamically, the keyboard can be in common use between a lefty and a righty easily, but considering a variety of factors, what is employed here is a hard keyboard which layouts do not display dynamically).

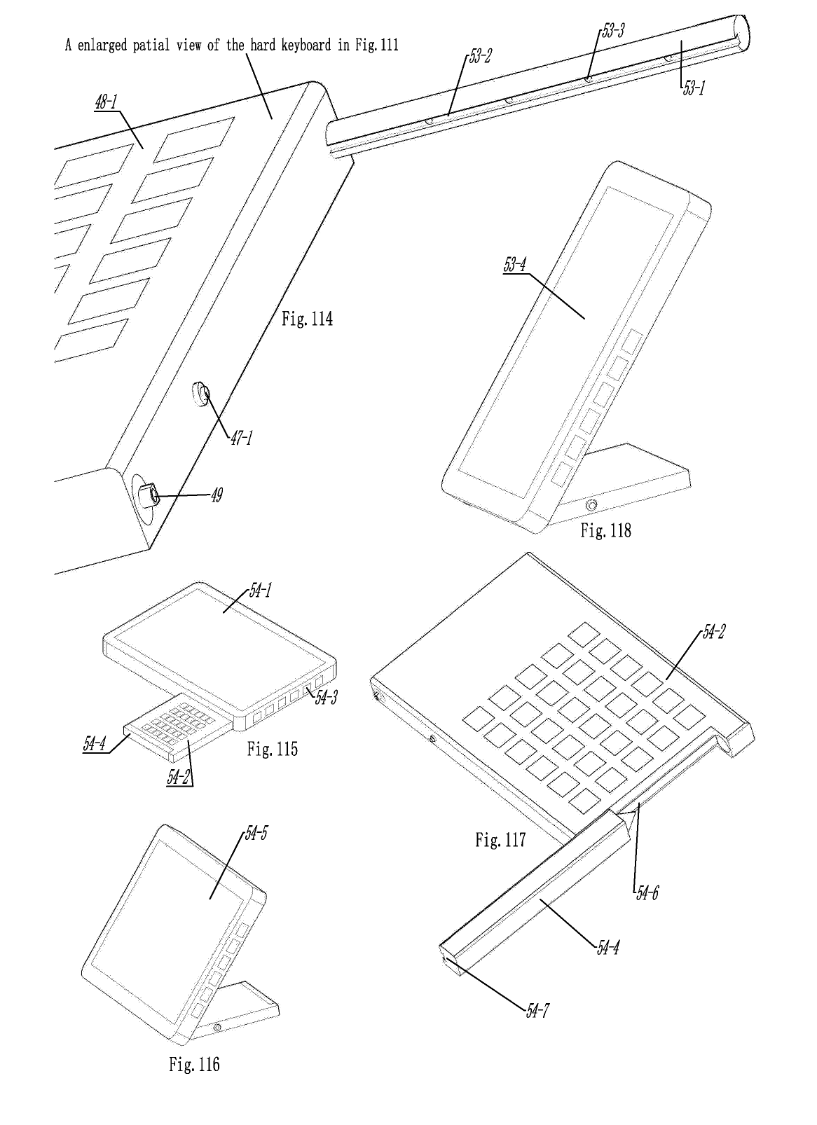

\textcircled{2} 54-1 in FIG. 115 is another foldable hard keyboard tablet. Hard keyboard 54-2 is at the bottom side of the tablet and side-keys 54-3 are on the right side of the tablet. Touch pen 54-4 in FIG. 117 used as a support rod is different from the above touch pen 53-1 in FIG. 114. Touch pen 53-1 is inside the keyboard and its section is oval. And Touch pen 54-4 is outside the keyboard and its section is round rectangle. Touch pen 54-4 is connected with the keyboard by trapezoidal guide way 54-7 inside the touch pen and trapezoidal guide rail 54-6 on the keyboard. A limit mechanism is configured between the guide way and the guide rail (please refer to the above 53-1, 53-2 and 53-3). 54-5 in FIG. 116 is a view of the tablet standing. Besides, the other aspects are the same as the foldable hard keyboard tablet in FIG. 107.

(f) Flip hard keyboard tablets. Two kinds of flip hard keyboard tablets are illustrated in FIGS. 119 and 123. A transparent flip hard keyboard tablet without a keyboard cover is illustrated as 55-1 in FIG. 119. A common flip hard keyboard tablet is illustrated as 57-1 in FIG. 123. The hard keyboard is connected with the tablet physically and/or electrically by connection ribbons 64. When the hard keyboard is flipped frontward to be on the touch display screen of the tablet, it is ready for input as 55-1 and 57-1. When the hard keyboard is flipped backward and folded, and keyboard limit spring balls 60-5 match and joint with support limit pits 60-4(just as the name implies, it is also used as the limit pits of the support) at the two sides of the keyboard room, the hard keyboard is received into the keyboard room as 59. Connection ribbons 64 are made from soft materials with strong toughness, and arranged alternatively. The two ends of each ribbon are connected with the hard keyboard and the tablet respectively. Support 60-1 is connected with hard keyboard 62 by a rotation axis/axes. Whether the rotation axis/axes is/are a controlled rotation mechanism(s) or not should be determined according to the thickness of the keyboard and the size of the keyboard frame etc. A plurality of pairs of support limit pits 60-4 are arranged equidistantly along the two sides of the keyboard room in the tablet back. When the hard keyboard is flipped backward and the support on the hard keyboard is pulled up, a pair of support limit pits match and joint with support limit spring balls 60-2 at the two ends of the top horizontal bar of the support to be able to support the tablet stably as 58. A plurality of mini-protrusions 60-3 can also be configured on the tablet back and outside the keyboard room in parallel with top horizontal bar 60-1 of the support, which can be used to match and joint with the horizontal bar to support the tablet with a larger freedom of inclination. Magnets can also be configured with the support horizontal bar and the mini-protrusions to be used to fasten them(of course, we can also configure only a plurality of mini-protrusions with magnets both inside and outside the keyboard room equidistantly to replace the support limit pits and the support limit spring balls). When touch pen 61 which is able to be used as a support rod, is drawn out and cooperates with the hard keyboard and the support, the tablet can be put up in another orientation (please refer to 41-A in FIG. 109). A limit mechanism between the touch pen and the hard keyboard can be configured to prevent the touch pen from sliding freely (please refer to 53-1, 53-2, 53-3 in FIG. 114). If the keyboard is too thin to receive the touch pen having a good hand feel, touch pen 61 in FIG. 122 can be degenerated into only a support rod, or even the support rod can be omitted too. If the touch pen is necessary, it can also be placed at the front end of the hard keyboard near the connection ribbons. When the hard keyboard is flipped frontward to be on the tablet front surface, it is fastened to the tablet by magnets 56. When support 60-1 is folded and stacked on the hard keyboard, it is fastened by magnets too (or by buckles).

Transparent flip hard keyboard 55-2 is used to transmit mechanical and electrical information etc. of the pressed keys to the soft keyboard which is under the hard keyboard and on the touch display screen of the tablet. At least the top of each key of the hard keyboard is transparent. And the hard keyboard should be made from materials which has a good hand feel and is good for transmitting force, electricity and the other information of the pressed keys. In fact, it is a hand-feel optimizing tool of the soft keyboard of the tablet. It employs a 6*6 matrix, and the soft keyboard on the touch display screen employs a one-hand keyboard layout with a 6*6 matrix as 22 in FIG. 25, and one row of soft side-keys is always redundant. In this way, when the user holds the tablet at the left side and cannot operate the side-keys on the right side, or when the user uses the keyboard with a single hand in leisure occasions, these soft side-keys can replace the side-keys on the right side, this certainly provides convenience for a lefty or a one-hand user too. Of course this keyboard layout with redundant side-keys can be not employed too. 57-2 in FIG. 123 is a common flip hard keyboard, the electrical connection between the keyboard and the tablet is realized by mini-conductor(s) inside the connection ribbons or wirelessly. The characters not tagged on the hard keyboard and nested sub layouts should be mapped onto character dynamically-mapping zone 57-3 at the left of hard keyboard 57-2. Of course the characters tagged on the hard keyboard can also be mapped onto the zone.

FIG. 124 is a transparent flip hard keyboard tablet with a keyboard cover. Keyboard cover 65-6 in FIG. 128 is connected to the tablet by an axis/axes at the tablet back. When the keyboard cover is unfolded and inserted into support groove 65-7 and fastened to the groove by magnets, it can be used as a support to put up the tablet in four attitudes. 65-1 in FIG. 124 is a view of the tablet standing in a large inclination. 65-2 is a view of the tablet standing in a small inclination. 65-3 is a view of the tablet standing in a small inclination in another orientation. 65-4 is a view of the tablet standing in a large inclination in another orientation. The keyboard cover may also be inserted between the rows of the keyboard for the user to change the inclination in which the tablet stands. When the keyboard is flipped backward, folded and received into the keyboard room, the keyboard cover covers the keyboard shown as 65-5. The keyboard cover is fastened to the keyboard and the tablet by magnets or buckles. Except the keyboard cover and the support mechanism, a transparent flip hard keyboard tablet with a keyboard cover is the same as one without a keyboard cover completely. The side-keys of the above 3 kinds of tablets are on the right side of the tablet. One of the benefits of a flip hard keyboard is that the hard keyboard body can be made thicker than its keyboard room, so when the hard keyboard is folded and collapsed, it can be received into the keyboard room by means of proper compression. A transparent flip hard keyboard tablet is preferred. A flip hard keyboard is also suitable for a cellular phone which has a space to be used as a hard keyboard room as 65-8 in FIG. 130.

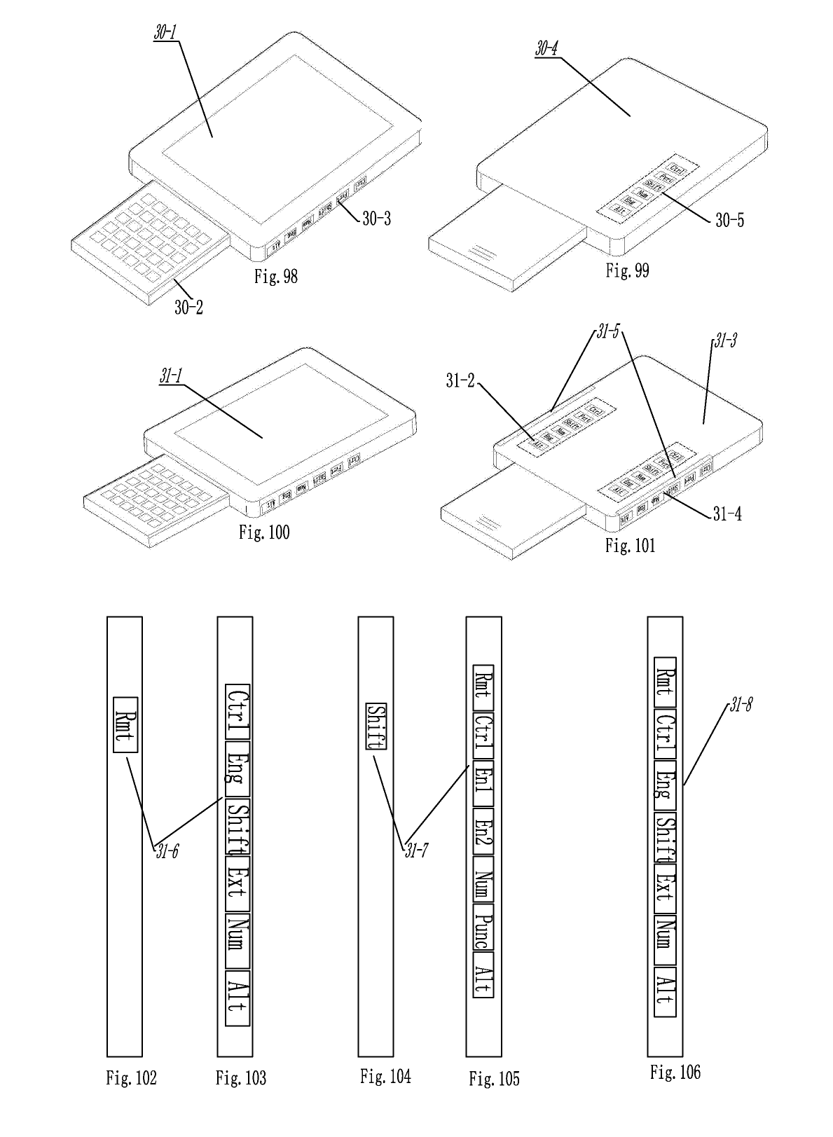

(H) Handheld keyboards. The solution can be combined not only with a handheld digital device very well, but also with a part (including touch pad, touch screen and touch display screen etc.) used as a mouse touch pad to establish a portable handheld keyboard. There are 3 kinds of handheld keyboards given in FIGS. 138, 139 and 140. (a) 76-1 in FIG. 138 is a bar handheld keyboard. The lower half is a hard keyboard, and the upper half is a touch pad 76-2 which is similar to a notebook's touch pad. The locations of the hard keyboard and the touch pad can also be swapped, i.e. the touch pad is at the lower half and the hard keyboard is at the upper half. A plurality of side-keys are configured on the right and left sides of the handheld keyboard, one of which can be a Rmt (short for Remote) key. Please refer to side-key layout 31-6 in FIGS. 102 and 103. When the Rmt key is touched and/or pressed, the handheld keyboard is used as a remote and map the remote layout 19-3 in FIG. 22. Only when a finger/touch pen is touching and/or sliding on the touch pad, some of the side-keys can be reused as the mouse buttons, otherwise the side-keys can only be used to cooperate with the keyboard. (b) A flip handheld keyboard 77 comprises a transparent flip hard keyboard and a touch display screen under the keyboard. When the keyboard is stacked onto the touch display screen, it is used as a keyboard, and when the keyboard is flipped and opened, it is used as a mouse touch pad. Please refer to FIG. 119 and the section about the transparent flip hard keyboard tablet for more details. The biggest benefit of this handheld keyboard is that its function is completely independent, and the devices receiving its inputs need not map nested sub layouts and the characters not tagged on the hard keyboard. The configuration of side-keys is the same as the above bar handheld keyboard. (c) A double-face handheld keyboard 79-1 in FIG. 140 comprises a front hard keyboard and a back touch pad 79-6. Two sets of side-keys 79-2 and 79-3 are configured on the left and right sides of the keyboard, which are used to cooperate with the keyboard and the touch pad respectively. When the side-keys cooperating with the keyboard on the right side is enabled, the keyboard is enabled accordingly, and the side-keys on the left side(but a side-key should be reserved to be used as the Rmt key) and the touch pad are disabled at the same time; when the keyboard is flipped over transversely, the side-keys cooperating with the touch pad on the left side (in fact on the right side at this time) is enabled, the touch pad is enabled accordingly, and the keyboard and the side-keys at the right side(but a side-key should be reserved to be used as the Rmt key to reuse the key zones of the touch pad as multimedia control keys) are disabled at the same time. The touch pad can employ touch pad layout 75-2 in FIG. 137 or 19-2 in FIG. 21 which includes an Fn key which can reuse the key zones as multimedia control keys even though the handheld keyboard is held by a single hand. A lefty button 79-5 in FIG. 143 is configured on the bottom side of the keyboard, so the keyboard is in common use between both a lefty and a righty. The connection between a handheld keyboard and the device(s) receiving its input, can be realized by a cable such as a USB cable, or wirelessly such as the Bluetooth technology. If they are connected wirelessly, battery cartridge(s) 79-4 are configured at the top and/or bottom side of a handheld keyboard. Retention hooks 79-7 for a tablet or a cellular phone are configured at the right of the top and bottom sides of the keyboard, which provide a convenience for the user of a device without a hard keyboard. When the retention hooks hook at the right side of a phone or a tablet, and is held by a left hand together with the phone or the tablet, the handheld keyboard can be used as the hard keyboard of the phone or the tablet. 79-7 in FIG. 143 is a view of a retention hook stretching out. The hooks should be rotated over at the bottom and top sides of the handheld keyboard to hide when not in use. And the hooks should be made from soft and strong materials, so they can be deformed appropriately to match devices with different side shapes very well. If don't care about redundancy, the other two retention hooks may be configured at the left of the top and bottom sides of the keyboard, in this way, the keyboard can be in common use between both a lefty and a righty. The above flip handheld keyboard is fit for configuring retention hooks too. A handheld keyboard should employ number and punctuation layout which includes arrow keys etc. as 19-1 in FIG. 20. Retention hooks can also be replaced by a plurality of mini suction cups configured on the back touch pad. A handheld keyboard can also integrate device(s) such as wireless microphone, laser pointer etc. to further expand its function. A handheld keyboard can also integrate a mobile power to be used as a mobile power.

In order to enhance the function of the touch pad of a handheld keyboard, the touch pad can be divided into 9 key zones as 75-2 in FIG. 137. Wherein Surf and Chat are used for surfing the web and instant messaging respectively, Fun is used for entertainment. Surf, Chat and Fun can launch a default application or an application menu. Left, Mid and Right correspond to the left, middle and right mouse buttons respectively, and in this way, a handheld keyboard has 3 sets of mouse buttons: reusing a plurality of side-keys, simulated by fingers, and some of the key zones on the touch pad here. The 3 bottom key zones are the frequently-used keys: Home, Back and Recent of a cellular phone or tablet. The corresponding upper keys of the 9 key zones are icon keys which are the frequently-used keys of a remote and enabled when the Shift side-key is pressed or the Fn key on the keyboard is locked. When the handheld keyboard is larger, the leftmost part of the touch pad can be used only for the left mouse button as 75-5. Both the grid and the key names of the key zones may be printed with light color and dashed lines, of course they can be not printed too, or only the grid is printed and the key names are described in the user's manual.

In order to improve the mouse operations of the touch pad, a mouse control action is added newly, i.e., when a finger(can also be a touch pen) controlling mouse cursor slides towards the edge of the touch pad and stops at the edge, the cursor on a display device(can also be multiple display devices) go on moving by inertia until the cursor gets to the edge of the display device, or until the touch action of the finger controlling the cursor changes, for example, the finger changes the sliding direction or leaves the touch pad before or when the cursor gets to the edge of the display device. In this way, we need not repeat sliding with the finger continuously when the cursor needs to be moved on the display device for a long distance. As 76-3 shown in FIG. 138, when a finger slides from point A to B, the cursor moves commonly, but when the finger stops sliding at point B, the cursor will go on moving by inertia toward the edge of the display device until it gets to the edge of the display device. And before or when the cursor gets to the edge of the display device, if the finger change the sliding direction, for example, from point B to D or B to C along the edge of the touch pad, the cursor restore moving commonly. And when the finger stops again at point C after sliding from B to C, the cursor start to move by inertia again. And when the finger slides from point C to E or C to F, the cursor restore moving commonly again. We can do that by sending the same mouse moving message in the same frequency when the cursor needs to be moved by inertia. In addition, a handheld keyboard can also use the simulated mouse solution described above.

In addition, we can zoom the objectives out and in on a controlled display device(s) by pinching in and out on the touch pad, and rotate the objectives by circling with a finger clockwise and counter-clockwise on the touch pad. A handheld keyboard can replace a PC keyboard to be used in a lot of occasions such as controlling PC(s), smart TV(s), projector(s),TV box(es),disk player(s), smart glasses, head-mounted virtual display device and so on.

When a handheld keyboard is held by a single hand, we can redefine and reuse the keys of the keyboard according to the requirements of the controlled device. An example is given as a remote layout 19-3 in FIG. 22. The keys on layout 19-3 is the universal control keys of a remote which is used to control TV, projector, set-top box and multimedia device etc. The fast forward and backward keys as shown in 19-3 of FIG. 22 are used to accelerate playing and rewinding, or to launch a menu with various speeds to allow the user to select to accelerate playing and rewinding, or to slide the indicator on a play progress bar. The functions of F1-F12 are defined and explained by the controlled devices, for example, to switch between TV and broadcast signals (of a satellite TV set-top box), or to switch between TV and teletext signals (of a cable TV set-top box) and so on.

One handheld keyboard can control multiple controlled devices if a display device receiving the inputs and controls of the handheld keyboard can forward the received inputs and controls to the target controlled device providing signal source currently. In order to avoid confusions raised from the same functions such as adjusting volume between the display device and the target controlled device, a menu item which is used to control the display device like a TV etc. itself should be added into the signal resource menu of the display device, or/and a DorS (short for display device or source device) key is configured to switch the device controlled by the handheld keyboard currently as shown in 19-3 in FIG. 22.

75-1 in FIG. 137 into which 24-2 in FIGS. 28 and 19-3 in FIG. 22 are incorporated, is a standard hard keyboard layout with a remote function, the leftmost label on each key is for remote and enabled when the handheld keyboard is held by a single hand, or the Remote side-key is pressed/touched. Wherein the Fn key is for using each remote key dually. For example, the numeric key 5 is used as play/stop key when Fn is unlocked and as key 5 when Fn is locked. The holding distinction between by one hand and by two hands is determined by whether the side-keys are held correctly or not, this has been described in the section: Avoiding mis-operation of side-keys, so it is not repeated here anymore. When held by a single hand, the default layout of the main keyboard is a remote layout. Please note that even though a handheld keyboard is held by two hands, if the side-keys are not held correctly and enabled, it is yet used as a remote. Such a handheld keyboard which main keyboard is reused can also be used to control industrial devices, the other home and office devices. Of course, the functions of the keys should be defined correspondingly according to the actual requirements and the specific application occasions. A handheld keyboard which has a hard keyboard with the remote function should employ standard layout 75-1 in FIG. 137. When a double-face handheld keyboard is used as a remote and operated by a single hand, whether the keyboard or the touch pad is operated by the user currently can be determined according to the keyboard attitude sensor(s), and the corresponding operation face is enabled or disabled accordingly.

(I) A handheld digital device is used as a handheld keyboard. A handheld digital device employing the solution of this invention can be transformed to be a handheld keyboard with the aid of soft and hard wares. On the basis of the keyboard of a handheld digital device, all or a part of the touch screen of the device is used as the mouse touch pad of a handheld keyboard, and then connect the device to the controlled devices receiving the input and controls of the device by a cable or wirelessly, a convenient and user-friendly handheld keyboard is there. A handheld digital device able to be used as a handheld keyboard with remote function should use a side-key layout as 31-6 in FIGS. 102 and 103, 31-7 in FIG. 104 and 105 or 31-8 in FIG. 106. Side-key layout 31-6 is applicable to a cellular phone. Side-keys: Ctrl, Eng, Shift, Ext, Num and Alt are configured on the right side. Side-key Rmt is configured at the upper of the left side. Rmt is short for remote. Ext is used for inputting characters or commands only one of which is required to be inputted one time, for example, such as F1˜F12, numeric keys: 1˜10 which is used for selecting a target word from candidate words of a input method. When Ext is pressed/touched, the other side-keys' pressed/touched or released statuses need not be changed, and after one input is completed, Ext is released by itself automatically. 31-8 is applicable to a tablet. Rmt is configured at the upper of the right side together with the other side-keys. Of course Rmt can also be configured on the back of the tablet. 31-7 is applicable to a cellular phone too. Side-keys: Rmt, Ctrl, En1, En2, Num, Punc and Alt are configured on the right side and Shift is configured at the upper of the left side. 31-7 is also applicable to a tablet if Shift is configured on the back of the tablet. Side-key layout with a Rmt key as 29-B1, 29-B2 in FIGS. 90 and 29-B3 in FIG. 91 is applicable to a tablet too. In the above side-key layouts, there is not the Fvrt key. The Fvrt's function can be realized by the other methods, for example, a composite key: Ctrl+SB (space bar), or configuring a Fvrt/Eng key on/near the character dynamically-mapping zone. A slide phone is the best one to be used as a handheld keyboard. A handheld digital device should reserve the handheld keyboard transforming function for the user to use easily. If a handheld digital device does not reserve the function, it should be allowed to realize the function by setting up a special software/software package or upgrading the OS. In the same way, if a controlled device has not the function receiving the inputs and controls from a handheld digital device used as a handheld keyboard, it should be allowed to realize the function by installing a corresponding software/software package or upgrading the OS, and even adding a proper hardware such as a Bluetooth device and USB adapter etc.

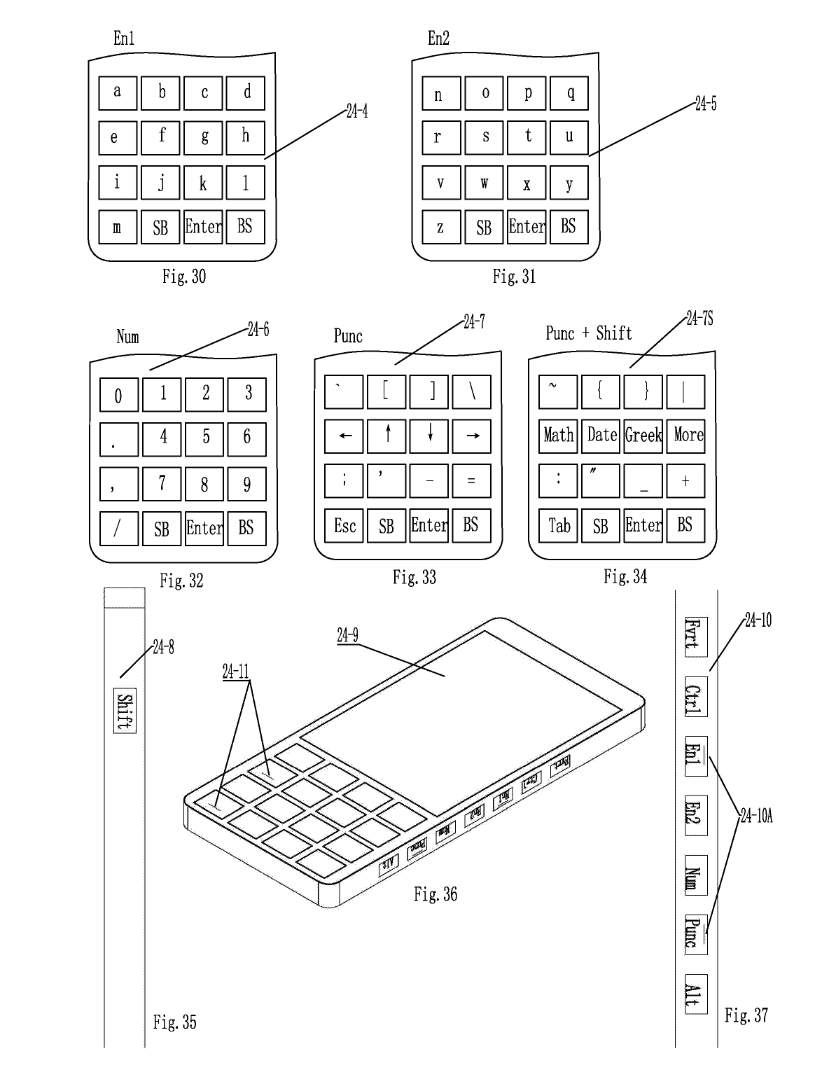

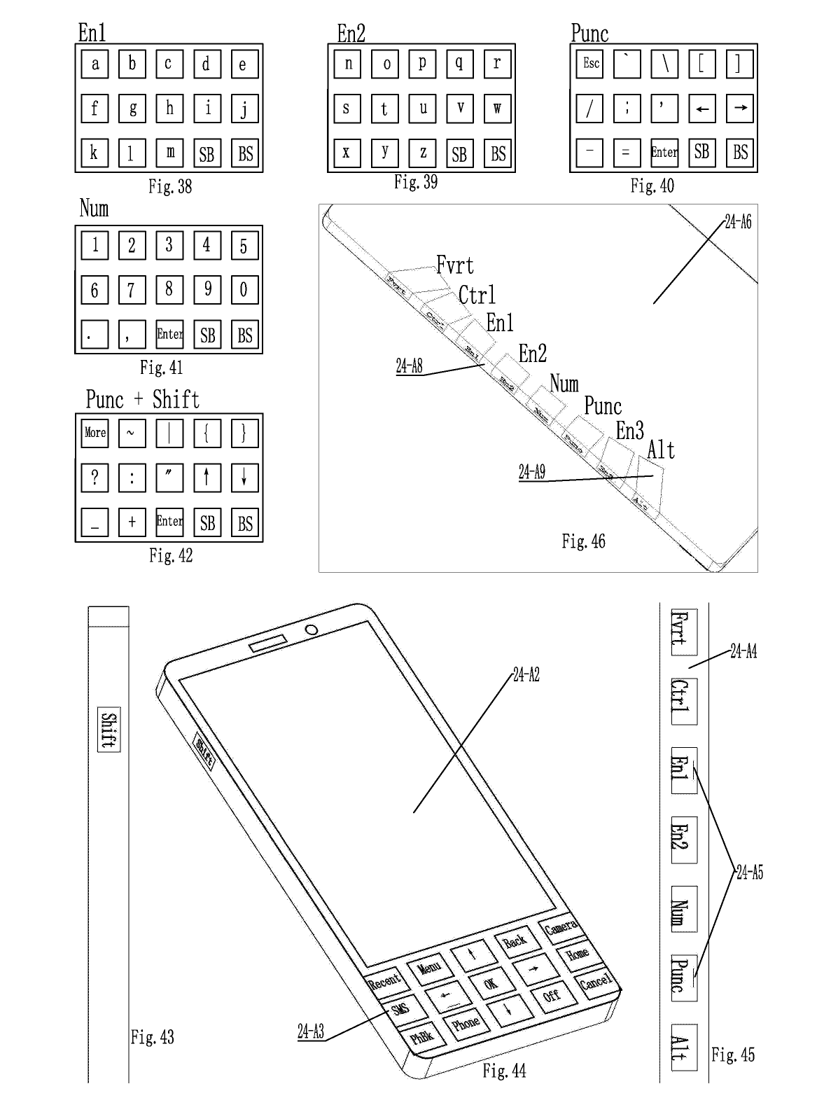

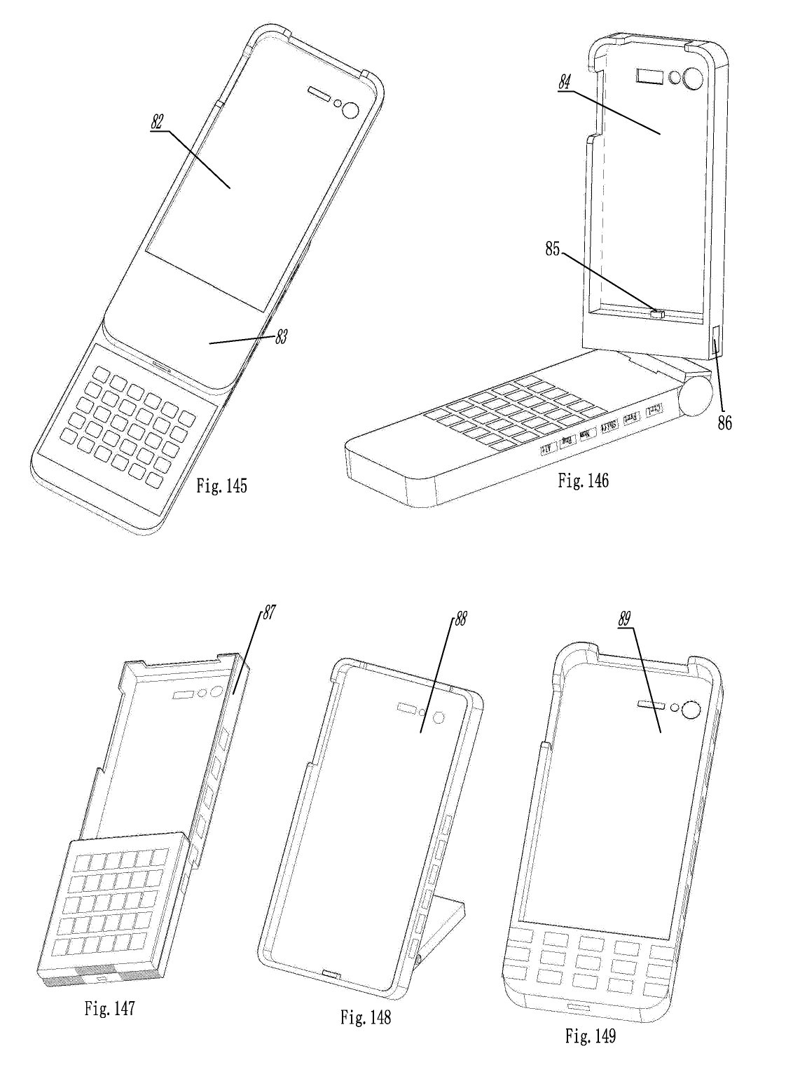

(J) Cellular phone keyboard cases. In order to let the user of a soft keyboard bar phone to make use of the benefits of a hard keyboard, 5 cellular phone keyboard cases are given in FIGS. 145-149. 82 and 84 respectively are a slide cellular phone keyboard case and a flip cellular phone keyboard case with a rotatable jacket. 87 is a flip hard keyboard cellular phone keyboard case. 88 is a foldable hard keyboard cellular phone keyboard case. As for 87 and 88, please refer to the sections about flip hard keyboard tablets and foldable hard keyboard tablets. 89 is a bar cellular phone keyboard case which can be referred to bar cellular phones in FIG. 30 to FIG. 78. The electrical connection between a cellular phone and a keyboard case can be realized by either a wireless connection such as the Bluetooth technology or a wired connection such as the USB technology. If connected by USB, the USB connector of a keyboard case can be either a soft cable connector or a fixed hard connector as 85. The USB connector extends out to form a USB port at the bottom or the side of the case as 86, which is used to charge the phone and exchange data with the other digital devices. The USB cable is hidden under USB cable shield plate 83. The USB port of a case can be configured with a mechanism which disables the keyboard of the case when an external USB connector is inserted into the port. Of course, we do not have to do so too, and let the keyboard of the case and the external device(s) share the same USB port of the cellular phone at the same time. When the USB port of a cellular phone is not at the bottom side but at the other sides, the location of a hard USB connector like 85 or a soft cable USB connector should be changed correspondingly. If we remove the rotatable jacket from a flip cellular phone keyboard case with a rotatable j acket, it will become a flip cellular phone keyboard case. A slide cellular phone keyboard case is preferred. The above USB can be micro/mini USB or USB.

(K) Simulating logic of mouse buttons. When the simulated mouse is enabled by a finger touching on the touch display screen with a simulated mouse interface, Num, Eng and Fvrt (Taking side-key layout 25 in FIG. 82 as example) are reused as the left, right and middle simulated mouse button respectively. When Num or Eng is pressed, the relevant press button message is sent, when the finger or touch pen simulating the mouse leaves the touch display screen afterward, the relevant release button message is sent. When Fvrt is pressed at the first time, the press middle button message is sent, and when Fvrt is pressed again, the release middle button message is sent. And the middle button messages circulate like this. When the mouse buttons are simulated by fingers, the sending logic of the left and right mouse button messages are the same as the above, but the press and release middle button messages are sent synchronously at the beginning and end of scrolling by fingers which simulate the middle mouse button.

The followings are added newly in this continuation-in-part application.

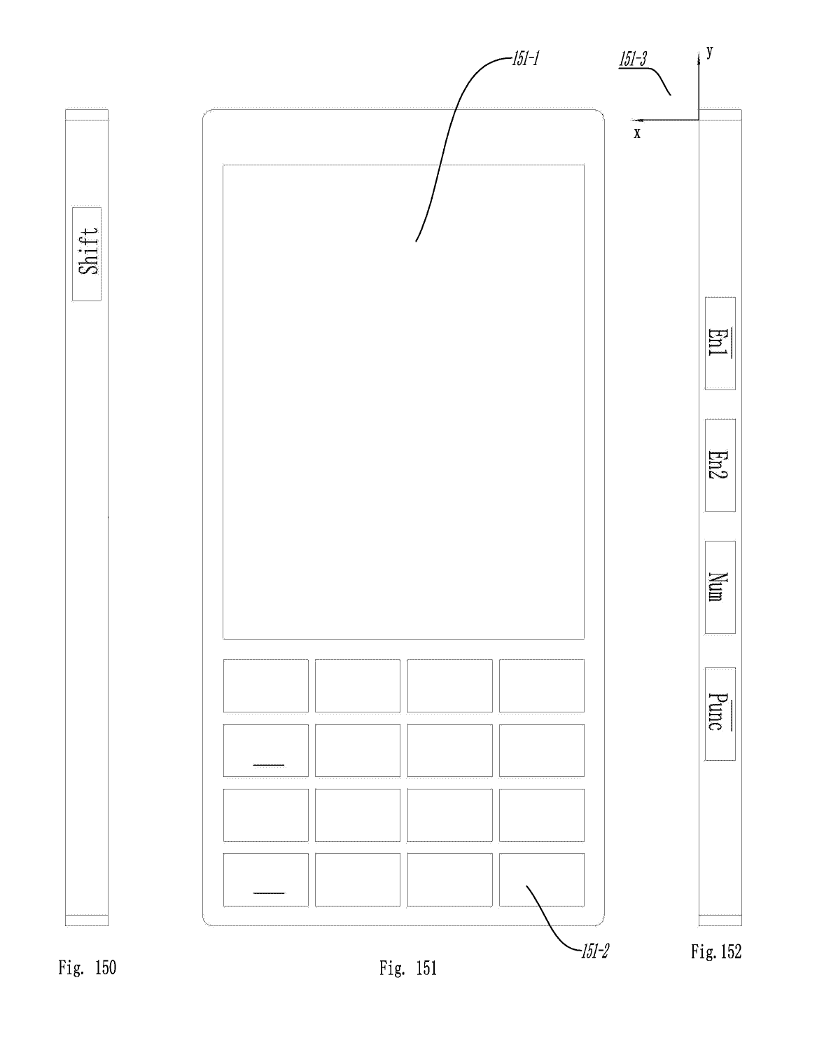

In order to clearly explain the side-key operation method: “releasing a finger corresponding to a target side-key first and then pressing/touching back at once” disclosed in the former description, a mobile phone as shown in FIG. 35-37 is simplified to be a mobile phone as shown in FIG. 150-152. Only four side-keys: En1, En2, Num and Punc are configured at the right side and the other three side-keys: Fvrt, Ctrl and Alt are removed as shown in FIG. 152. A side-key Shift is configured at the left side as shown in FIG. 150. A physical main keyboard 151-2 is configured at the bottom and a touch screen 151-1 is configured at the upper part as shown in FIG. 151.

FIG. 151 phone is held by a left hand, and all of the side-keys are operated by fingers of the left hand holding the phone as shown in FIG. 153, and the physical main keyboard 151-2 and the touch screen 151-1 are operated by a right hand.

FIG. 153-155 are graphical representations about the side-key operation method: “releasing a finger corresponding to a target side-key first and then pressing /touching back at once”.

FIG. 153 shows that a left hand is holding FIG. 151 phone steadily, meanwhile, the thumb 90 is holding the side-key Shift naturally, and the index, middle, ring and little fingers are respectively holding the side-keys: En1, En2, Num and Punc naturally. The left hand holds the phone through holding the side-keys.

FIG. 153 is a situation before operating any side-key, all of the side-keys are held; FIG. 154 is a situation operating the side-key Shift by the thumb 90 being released; FIG. 155 is a situation after ending an operation of any side-key, all of the side-keys are held again.

FIG. 154 shows that the thumb 90 is released to be operating the side key Shift. And then at once the released thumb 90 holds (presses down/touches) the side-key Shift again as shown in FIG. 155, and an operation of the side-key Shift ends. In fact, FIG. 155 is the same as FIG. 153 completely. The side-key Shift is held by the thumb 90 both before and after the operation, and is released by the thumb 90 for an instant only in the middle of the operation. In contrast, by means of a common and traditional method operating a key, a key is always released, in other words, is not held/pressed down/touched both before and after an operation, and pressed down or touched only in the middle of the operation.

By means of this side-key operation method, the left hand's fingers holding FIG. 151 phone steadily are able to be used to very easily and comfortably operate the side-keys also held by the fingers and configured at the two sides. If by means of the common and traditional method operating a key, a user maybe uses the bulge of the thumb and the little finger of his/her left hand to hold FIG. 151 phone and let the other left fingers hang in the air to operate the side-keys, but it is very uncomfortable and difficult, and also the phone cannot be held safely and firmly.

If the side-key Shift is a physical key, when in an operation, a switch-off will be detected first and then a switch-on will be detected immediately or a switch-on will be detected first and then a switch-off will be detected immediately. After capturing this change, an operation of the side-key Shift can be determined.

If the side-key Shift is a touch key, when in an operation, a non-touch will be detected first and then a touch will be detected immediately. After capturing this change, an operation of the side-key Shift can be determined.

A method operating the other four side-keys: En1, En2, Num and Punc is the same as the method operating Shift. When operating En1, the left index finger holding En1 is released first and then presses down/touches En1 at once to hold En1 again; When operating En2, the left middle finger holding En2 is released first and then presses down/touches En2 at once to hold En2 again; When operating Num, the left ring finger holding Num is released first and then presses down/touches Num at once to hold Num again; When operating Punc, the left little finger holding Punc is released first and then presses down/touches Punc at once to hold Punc again.

In order to avoid mis-operation, all of the side-keys are initially configured to be disabled. At any time, if switch-on's/off's or touches of all of the side-keys: Shift, En1, En2, Num and Punc are detected at the same time, in other words, if all of the side-keys are held (pressed down or touched) respectively by the left thumb, index, middle, ring and little fingers at the same time, all of the side-keys are enabled to work. And after that, at any time, if a switch-on/off or touch of any of the side-keys is no longer detected, then FIG. 151 phone and all of the side-keys are no longer held by the left hand through all of its fingers, all of the side-keys enabled are disabled again.

If the side-keys: En1, En2, Num and Punc are configured on a multi-touch pad and each of them has a predetermined and fixed positon, determining an operation of each of them is the same as a touch side-key.

If the side-keys: En1, En2, Num and Punc are configured on a multi-touch pad and their positions are determined dynamically, determining their positions and operations is as follows:

Initially, all of the side-keys are configured to be disabled and the positions of the side-keys: En1, En2, Num and Punc are configured to be undetermined.

When a left hand holds FIG. 151 phone, the left thumb holds (presses down or touches) the side-key Shift and the left index, middle, ring and little fingers hold the multi-touch pad, four touch points on the multi-touch pad will be detected and the side-key Shift is also detected to be pressed down or touched at the same time, enable all of the side-keys.

According to a coordinate system 151-3, sort the four detected touch points from largest to smallest by y value (i.e., from top to bottom) to get a touch point series: pIndex, pMiddle, pRing and pLittle, each touch point is described by a (x, y) coordinate pair, i.e., pIndex(x, y) and so on. And then one to one match pIndex, pMiddle, pRing and pLittle respectively with the left index, middle, ring and little fingers, and furthermore with the side-keys: En1, En2, Num and Punc configured at the multi-touch pad, and then configure pIndex, pMiddle, pRing and pLittle to be the current positions of En1, En2, Num and Punc.

Assuming that at most one side-key is being operated at any time. So, at any time, if only three touch points are detected on the multi-touch pad, then a finger holding the multi-touch pad is released to be operating a side-key. The three touch points are represented by p31, p32 and p33 now, and then calculate a difference set between (p31, p32,p33 ) and (pIndex, pMiddle, pRing, pLittle). If the only element in the difference set is, for example, pIndex, then the left index finger is released to be operating En1, and so on. And after that, if four touch points are detected again on the multi-touch pad, then an operation of En1 ends, the left index finger hold the touch pad to touch and hold En1 again, and so on. And then, the detected new touch point is used to update pIndex and the current positon of En1, and so on.

After enabling all of the side-keys, at any time, if none of touch points are detected on the multi-touch pad, i.e., all of the left index, middle, ring and little fingers holding the multi-touch pad are released and leave the multi-touch pad, disable all of the side-keys and configure the positions of the side-keys: En1, En2, Num and Punc to be undetermined again.

And at any time when all of the side-keys are disabled and the positions of the side-keys: En1, En2, Num and Punc are undetermined, if four touch points on the multi-touch pad are detected and the side-key Shift is also detected to be pressed down or touched at the same time, enable all of the side-keys, and determine the positions of the side-keys: En1, En2, Num and Punc according to the above description.

If the side-keys: En1, En2, Num and Punc are configured at a multi-touch pad and their positions are determined dynamically, the finger-positioning marks at the side-key En1 and Punc are not necessary and are removed.

FIG. 160 is a touch mouse. A multi-touch pad 93 is configured at the front of the mouse. A left mouse button and a right mouse button are configured at the left and right of the touch pad 93 respectively. A third mouse button 92 is a touch button and configured at the left of the mouse. A multi-touch pad 94 is configured at the right side of the mouse, and a fourth mouse button and a fifth mouse button are configured at the front and back of the touch pad 94 respectively.

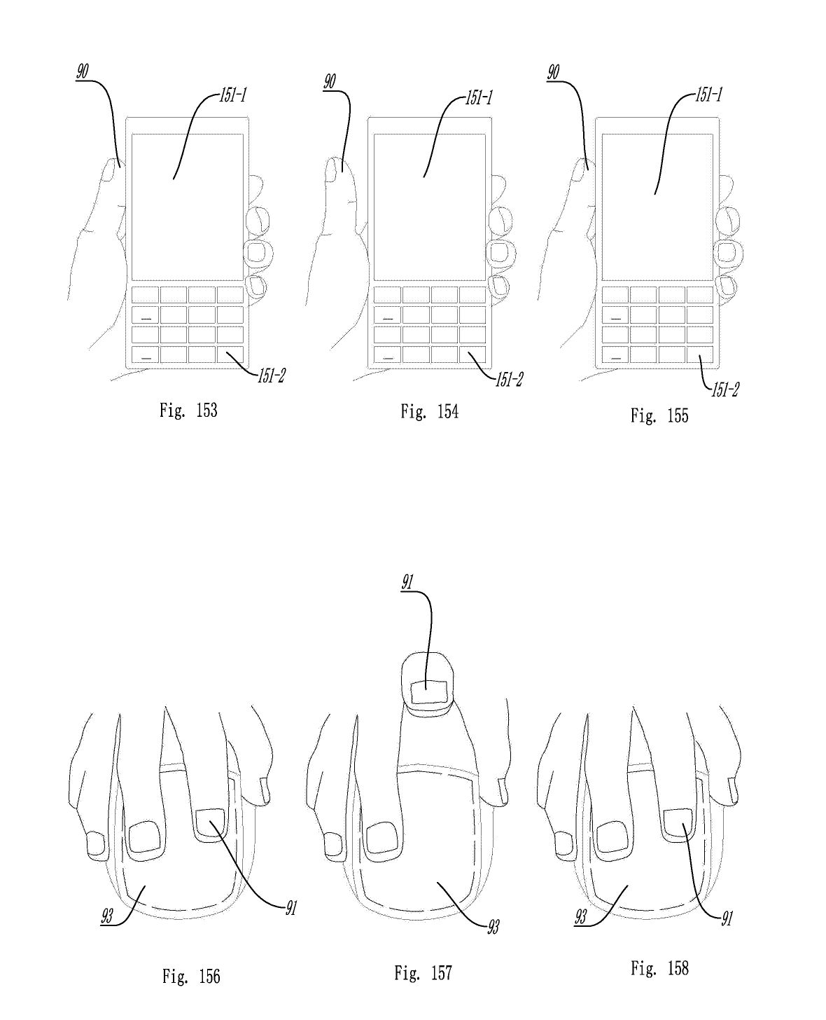

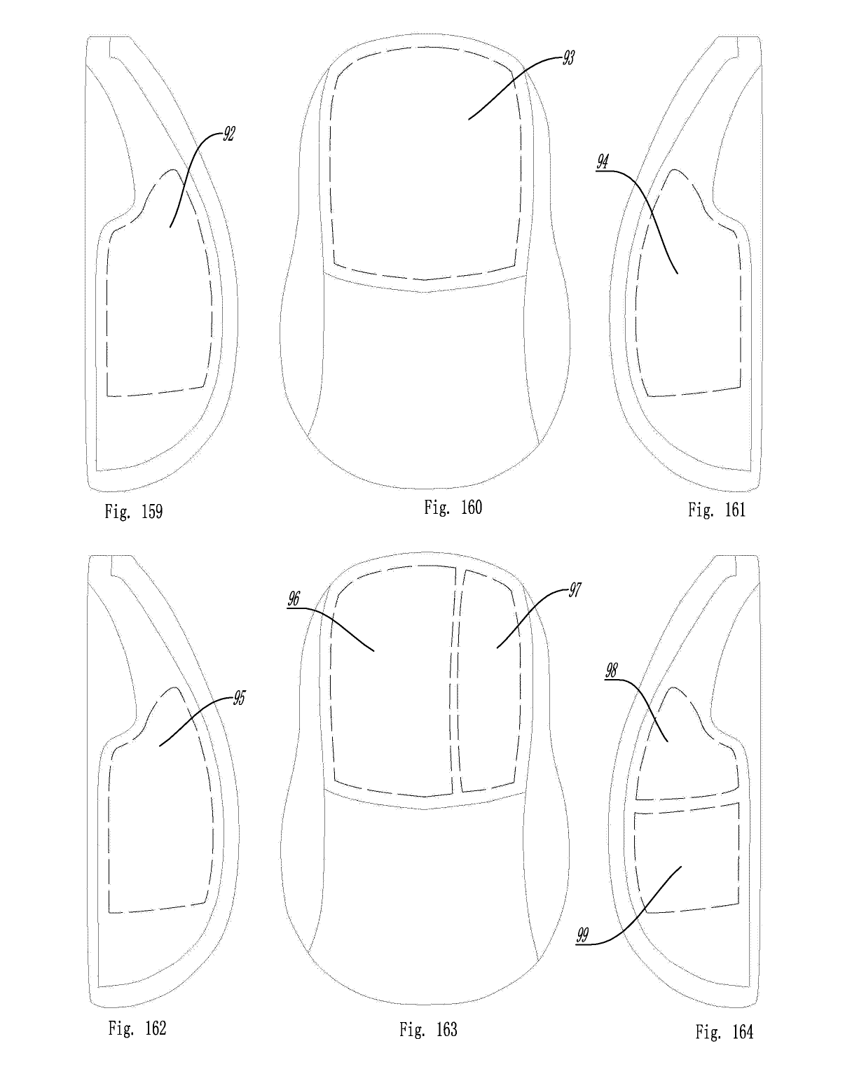

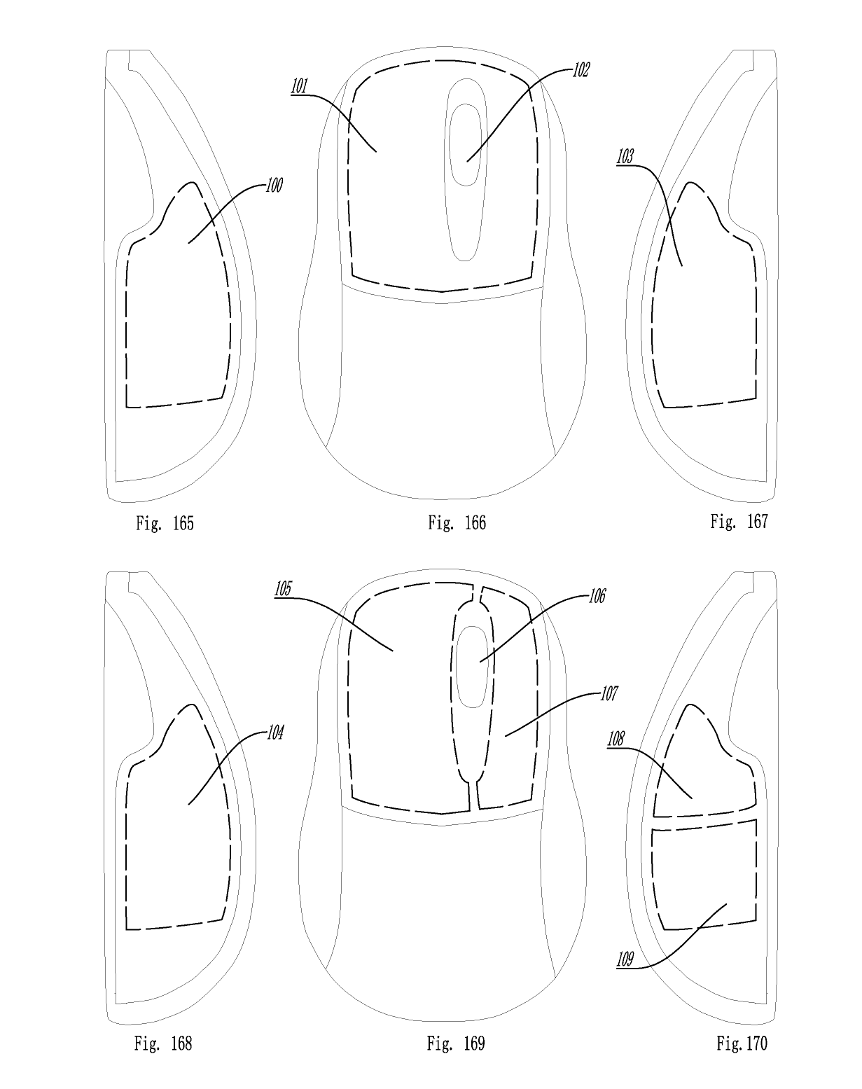

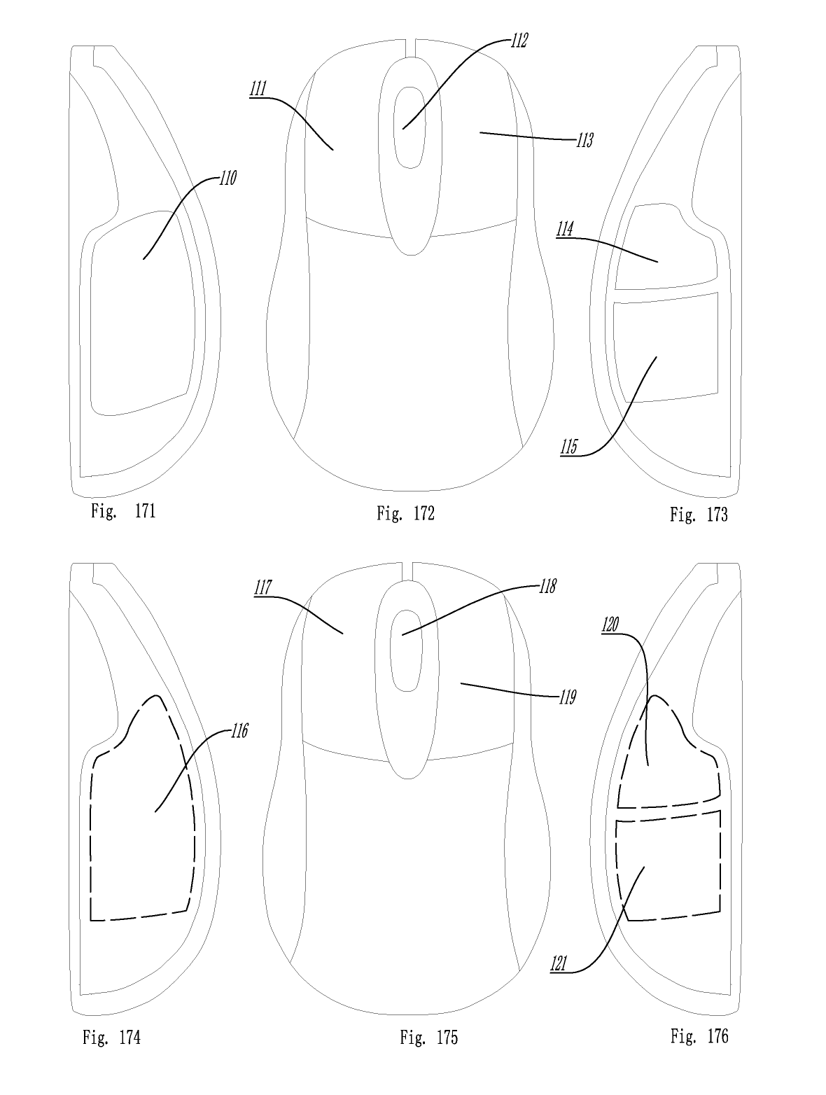

FIG. 156 is a front view of FIG. 160 mouse held by a right hand. The right index finger 91and the right middle finger of the right hand hold the touch pad 93 and also hold the left and right mouse buttons configured at the touch pad 93; the right thumb holds the touch mouse button 92; the right ring and little fingers hold the touch pad 94 and also hold the fourth and fifth mouse buttons configured at the touch pad 94.

Like a common and popular mouse, moving FIG. 160 mouse will move the cursor on a display. Besides, the right index finger 91′s swiping on the touch pad 93 will scroll the screen on the display. So, the mouse wheel and the middle mouse button are removed from FIG. 160 mouse.

When operating FIG. 160 mouse, all of the fingers of the right hand holding FIG. 160 mouse holds the left, right, third, fourth and fifth mouse buttons too, in other words, the right hand holds the mouse through holding the mouse buttons. When operating one of the mouse buttons, a finger holding a mouse button is released first and then touch it at once to hold it again. For example, when operating the left mouse button, the right index finger 91 holding the left mouse button as shown in FIG. 156 is released first as shown in FIG. 157 and then touch the left mouse button on the touch pad 93 at once to hold the left mouse button again as shown in FIG. 158, an operation of the left mouse button ends. FIG. 158 is the same as FIG. 156, the right index finger 91 holds (touches) the left mouse button both before and after the operation, and is released for an instant only in the middle of the operation.

When the right index and middle fingers hold and touch the touch pad 93, two touch points will be detected, and then sort the two touch points from left to right, the left touch point is the position touched by the right index finger and is configured to be the current positon of the left mouse button; the right touch point is the position touched by the right middle finger and is configured to be the current positon of the right mouse button. When operating the left mouse button, the left touch point corresponding to the left mouse button will disappear first and then be detected again at once following releasing the right index finger 91 first as shown in FIG. 157 and then using the right index finger 91 to hold and touch the touch pad 93 again at once as shown in FIG. 158. When capturing this change, an operation of the left mouse button is determined. The re-detected left touch point maybe is a little different from the former counterpart, and is used to update the current position of the left mouse button. In the same way, an operation of the right mouse button can be determined.

When the right ring and little fingers hold and touch the touch pad 94, two touch points will be detected, and then sort the two touch point from front to back, the front touch point is the position touched by the right ring finger and is configured to be the current positon of the fourth mouse button; the back touch point is the position touched by the right little finger and is configured to be the current positon of the fifth mouse button. When operating the forth mouse button, the front touch point corresponding to the fourth mouse button will disappear first and then be detected again at once following releasing the right ring finger first and then using the right ring finger to hold and touch the touch pad 94 again at once. When capturing this change, an operation of the fourth mouse button is determined. The re-detected front touch point maybe is a little different from the former counterpart, and is used to update the current position of the fourth mouse button. In the same way, an operation of the fifth mouse button can be determined.

In order to avoid mis-operation, FIG. 160 mouse and all of its mouse buttons are initially configured to be disabled. At any time, if a touch on the third touch mouse button 92, two touch points on the touch pad 93 and two touch points on the touch pad 94 are all detected together at the same time, in other words, a right hand holds FIG. 160 mouse and the right thumb, index, middle, ring and little fingers respectively hold and touch the third touch mouse button 92, the touch pad 93 to hold and touch the left and right mouse buttons, and the touch pad 94 to hold and touch the fourth and fifth mouse buttons, FIG. 160 mouse and all of its mouse buttons are enabled to work. And after that, at any time, if any touch is no longer detected on the touch mouse button 92 and the touch pads 93 and 94, then FIG. 160 mouse are no longer held by the right hand through all of its fingers, the mouse and all of the mouse buttons is disabled again.

In order to implement an operation such as a left mouse button's being pressed and held of a common and popular mouse, it is ok to release the right index finger 91 continuously until an operation of the left mouse button ends, in other words, the right index finger 91 does not have to hold and touch the touch pad 93 again at once after being released, and before re-detecting the disappearing left touch point on the touch pad 93, the left mouse button is seemed to be “pressed and held”. The right, third, fourth or fifth mouse button of FIG. 160 mouse can also be operated in the same manner by the right middle, thumb, ring or little finger.

An alternative method using FIG. 160 mouse is that when operating the mouse, the mouse is held at the third touch mouse button 92 and the touch pad 94 where the fourth and fifth mouse buttons are configured only by the right thumb, ring and little fingers, together with the right index and middle fingers hanging in the air. The third, fourth and fifth mouse buttons are respectively held and operated by the right thumb, ring and little fingers by means of releasing the thumb, ring or little finger first and then holding and touching the touch mouse button 92 or the touch pad 94 at the front or back again by the right thumb, ring or little finger, and the third, fourth and fifth mouse buttons are all held by the right thumb, ring and little fingers before and after an operation. And the left and right mouse buttons are respectively operated by the right index and middle fingers by means of touching the touch pad 93 at the left or right by the index or middle finger first and then releasing the right index or middle finger again, and the right index or middle finger hangs in the air both before and after an operation, like operating a left or right mouse button of a common and popular mouse.

FIG. 163 is also a touch mouse. A separate left mouse button is configured on a touch pad 96 at the front left of the mouse; a separate right mouse button 97 is a touch one and configured at the front right of the mouse; a separate third mouse button 95 is a touch one and configured at the left side of the mouse; a separate fourth mouse button 98 is a touch one and configured at the front of the right side of the mouse; a separate fifth mouse button 99 is a touch one and configured at the back of the right side of the mouse. At least the mouse buttons: 95, 98 and 99 are held when operating FIG. 163 mouse and operated by means of releasing a finger holding a mouse button first and then using the finger to hold and touch the mouse button again. A right index finger swipes on the touch pad 96 to scroll the screen on a display.

FIG. 166 mouse is the same as FIG. 160 mouse except with a mouse wheel 102. Multi-touch pads 101 and 103 is at the front and the right side of the mouse; a touch mouse button 100 is at the left side of the mouse.

FIG. 169 mouse is the same as FIG. 163 mouse except with a mouse wheel 106. Configured separate right, third, fourth and fifth mouse buttons: 107, 104, 108 and 109 are touch buttons and a left mouse button is configured on a touch pad 105.

Although both FIGS. 166 and 169 mice have a mouse wheel, a right index finger can still swipe on the touch pad 101 or 105 in any direction to scroll the screen on a display.

FIG. 172 is a mouse with a mouse wheel 112. Physical left, right, third, fourth and fifth mouse buttons 111,113, 110, 114 and 115 are configured as shown in FIGS. 171, 172 and 173. And when operating the mouse, these mouse buttons are respectively held and operated by the right index, middle, thumb, ring and little fingers by means of releasing a finger holding a mouse button first and then using the finger to hold the button again, or at least the third, fourth and fifth mouse buttons 110, 114 and 115 are respectively held and operated by the right thumb, ring and little fingers by means of releasing a finger holding a mouse button first and then using the finger to hold the button again.

FIG. 175 mouse is the same as FIG. 172 mouse except three touch rather than physical mouse buttons 116, 120 and 121 are configured at the left and right sides as shown in FIGS. 174 and 176.

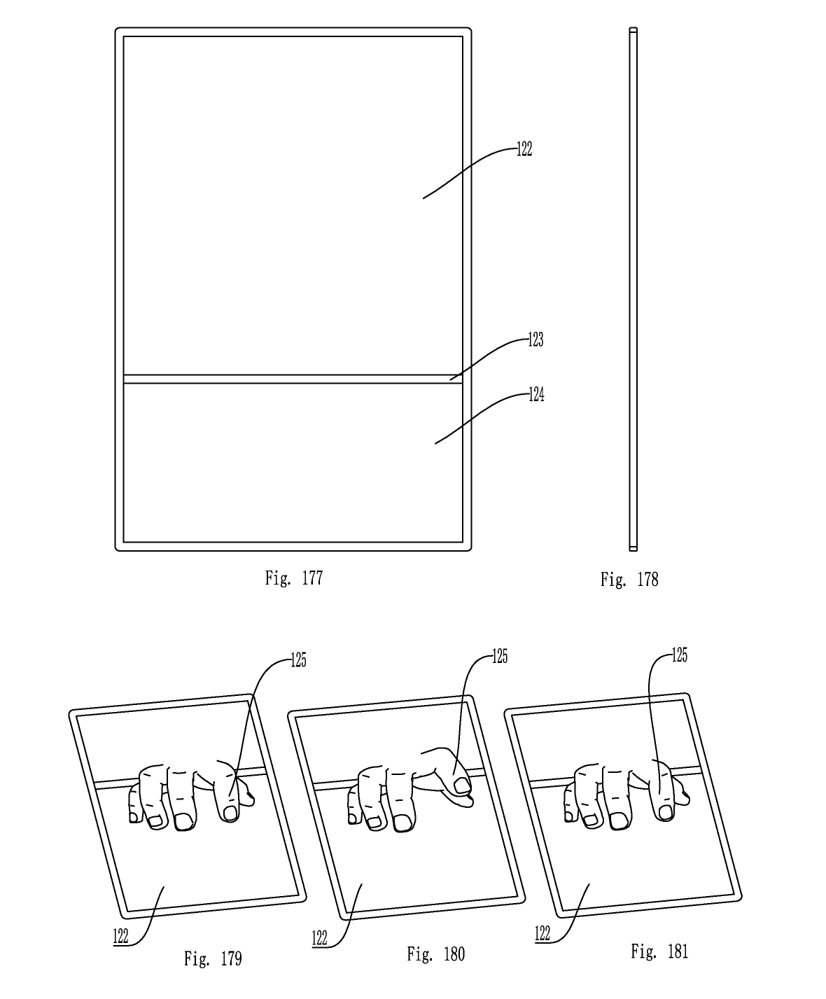

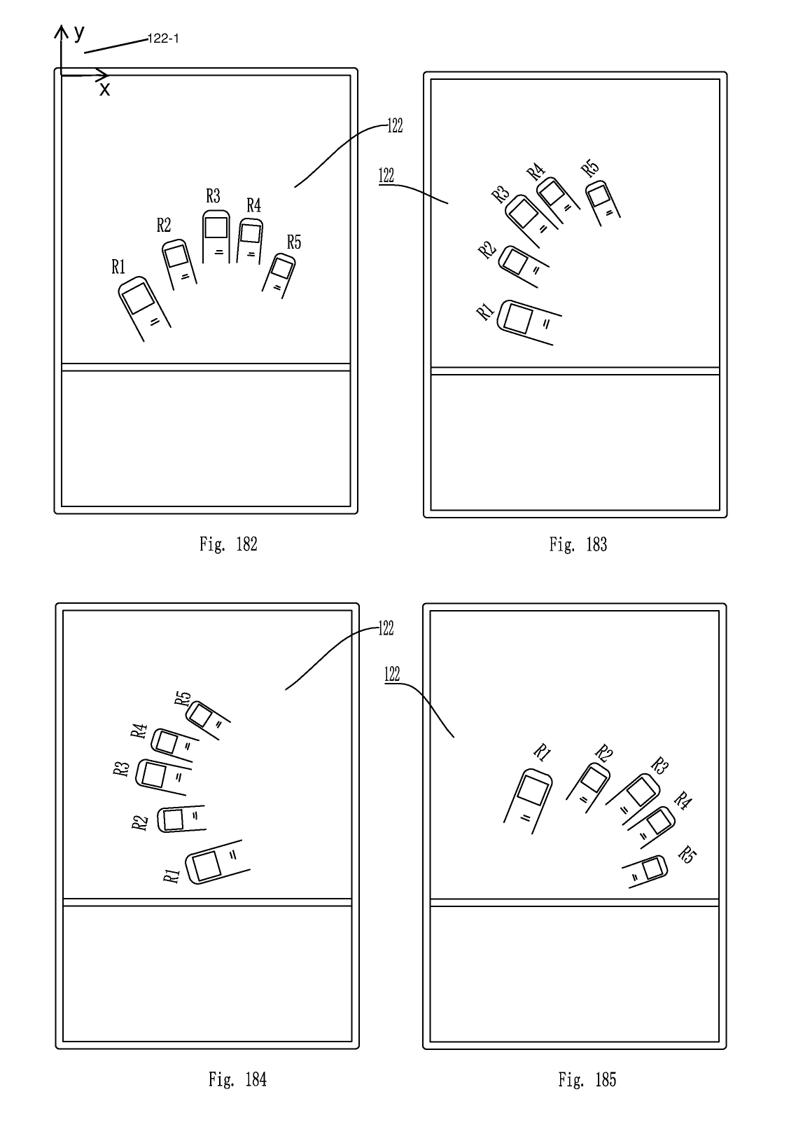

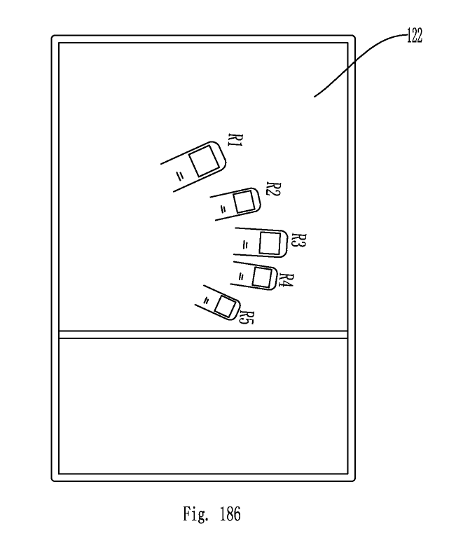

FIG. 177 is a touch-pad mouse comprising a multi-touch pad 122, a groove 123 and a palm rest pad 124. The touch pad 122 is used to move a cursor, scroll a screen and operate mouse buttons. When a user's finger(s) operating FIG. 177 mouse get(s) over the groove 123, the user will feel it to adjust his/her hand's operating position. The palm rest pad 124 is for the palm's resting of the hand operating the touch pad 122 when necessary.

When operating FIG. 177 mouse, all of the five fingers of a right hand touch the touch pad 122 as shown in FIG. 179, swiping all of the five fingers on the pad 122 moves the cursor on a display, and only swiping the index finger on the pad 122 scrolls the screen on the display.

Five mouse buttons: the third, left, right, fourth and fifth mouse buttons are configured at the touch pad 122 and respectively touched and operated by the right thumb, index, middle, ring and little fingers all of which touching the touch pad 122 by means of releasing a finger touching a mouse button first and then using the finger to touch the touch pad 122 to touch the mouse button again. For example, when operating the left mouse button, the right index finger 125 touching the left mouse button on the touch pad 122 as shown in FIG. 179 is released first as shown in FIG. 180 and then touch the touch pad 122 to touch the left mouse button again as shown in FIG. 181, an operation of the left mouse button ends. FIG. 181 is the same as FIG. 179, the right index finger 125 touches the touch pad 122 to touch the left mouse button both before and after the operation, and is released for an instant or a period of time only in the middle of the operation.

Initially, FIG. 177 mouse and all of its mouse buttons are configured to be disabled, and the positions of all of the mouse buttons are configured to be undetermined.

In order to determine the mouse buttons' positions and operations on the touch pad 122, a plurality of right-hand touch-gesture models are established as shown in FIG. 182-186. In FIG. 182 model, the topmost touch point is also the third point from left to right. In FIG. 183 model, the topmost touch point is also the fourth touch point from left to right. In FIG. 184 model, the leftmost touch point is also the third touch point from top to bottom. In FIG. 185 model, the topmost touch point is also the second touch point from left to right. In FIG. 186 model, the rightmost touch point is also the third touch point from top to bottom.

As shown in FIGS. 182-186, R1, R2, R3, R4 and R5 respectively represent the right thumb, index, middle, ring and little fingers. At any time, if five touch points are detected on the touch pad 122 at the same time, then all of the five right fingers touch the touch pad 122 together, and enable FIG. 177 mouse and all of the mouse buttons. The five touch points are respectively represented by p51, p52, p53, p54 and p55, and each touch point is described by using a (x, y) coordinate pair, i.e., p51 (x, y), and so on. According to a coordinate system 122-1, p51-p55 are sorted from smallest to largest by x value to become a new touch point series: pX1, pX2, pX3, pX4 and pX5, called X series, and meanwhile, from largest to smallest by y value to become a new touch points series: pY1, pY2, pY3, pY4 and pY5, called Y series, and then compare each touch point in X series with each touch point in Y series:

If pY1=pX3, then the right-hand touch-gesture is shown as FIG. 182, so pX1, pX2, pX3, pX4 and pX5 respectively correspond to the touch points of R1, R2, R3, R4 and R5. And then store pX1, pX2, pX3, pX4 and pX5 as pThumb, pIndex, pMiddle, pRing and pLittle.

If pY1=pX4, then the right-hand touch-gesture is shown as FIG. 183, so pY5, pY4, pX3, pX4 and pX5 respectively correspond to the touch points of R1, R2, R3, R4 and R5. And then store pY5, pY4, pX3, pX4 and pX5 as pThumb, pIndex, pMiddle, pRing and pLittle.

If pY3=pX1, then the right-hand touch-gesture is shown as FIG. 184, so pY5, pY4, pY3, pY2 and pY1 respectively correspond to the touch points of R1, R2, R3, R4 and R5. And then store pY5, pY4, pY3, pY2 and pY1 as pThumb, pIndex, pMiddle, pRing and pLittle.

If pY1=pX2, then the right-hand touch-gesture is shown as FIG. 185, so pX1, pX2, pX3, pY4 and pY5 respectively correspond to the touch points of R1, R2, R3, R4 and R5. And then store pX1, pX2, pX3, pY4 and pY5 as pThumb, pIndex, pMiddle, pRing and pLittle.

If pY3=pX5, then the right-hand touch-gesture is shown as FIG. 186, so pY1, pY2, pY3, pY4 and pY5 respectively correspond to the touch points of R1, R2, R3, R4 and R5. And then store pY1, pY2, pY3, pY4 and pY5 as pThumb, pIndex, pMiddle, pRing and pLittle.

And then, configure pThumb, pIndex, pMiddle, pRing, pLittle to be the current positions of the third, left, right, fourth and fifth mouse buttons.

Assuming that at most one mouse button is being operated at any time. So, at any time, if only four touch points are detected on the touch pad 122, then a finger is released to be operating a mouse button. The four touch points are represented by p41, p42, p43 and p44, and then calculate a difference set between (p41, p42, p43, p44) and (pThumb, pIndex, pMiddle, pRing, pLittle). If the only one element in the difference set is, for example, pIndex, then the right index finger is released to be operating the left mouse button, and so on. And after that, if five touch points are detected again on the touch pad 122, then an operation like a “left click” or “left-click and hold” of the left mouse button ends, the right index finger touches the touch pad 122 to touch the left mouse button again, and so on. And then, re-determine the touch gesture of the right hand on the touch pad 122 according to the above-described method and get a new series of pThumb, pIndex, pMiddle, pRing, pLittle and furthermore configure them to be the current positions of the third, left, right, fourth and fifth mouse buttons. Also, in a simple way, only the detected new touch point is used to update, for example, pIndex and the current positon of the left mouse button if only the right index finger is released and the other right fingers remain in place when operating the left mouse button, and so on.

After FIG. 177 mouse and its mouse buttons are enabled, at any time, if none of touch points are detected on the touch pad 122, then all of the right fingers are released to leave the touch pad 122, and disable the mouse and all of its mouse buttons and moreover configure the positons of all its mouse buttons to be undetermined again.

And at any time when FIG. 177 mouse and all of its mouse buttons are disabled and the positions of all of its mouse buttons are undetermined, if five touch points are detected on the touch pad 122, enable the mouse and all of the mouse buttons and moreover determine the positions of all of the mouse buttons according to the above description.

Now re-describe the embodiment as shown in FIG. 67 as follows:

FIG. 67 is a mobile phone comprising a main keyboard which comprises a 2*6 physical keyboard 24-C8 configured at the bottom of the phone and a four-row mapping keyboard 24-C7 configured on the touch screen 24-C6 of the phone(the mapping keyboard 24-C7 is previously called a character dynamically-mapping zone). An extension key can be realized by means of pressing down and releasing two or more keys of the physical keyboard 24-C8 simultaneously.

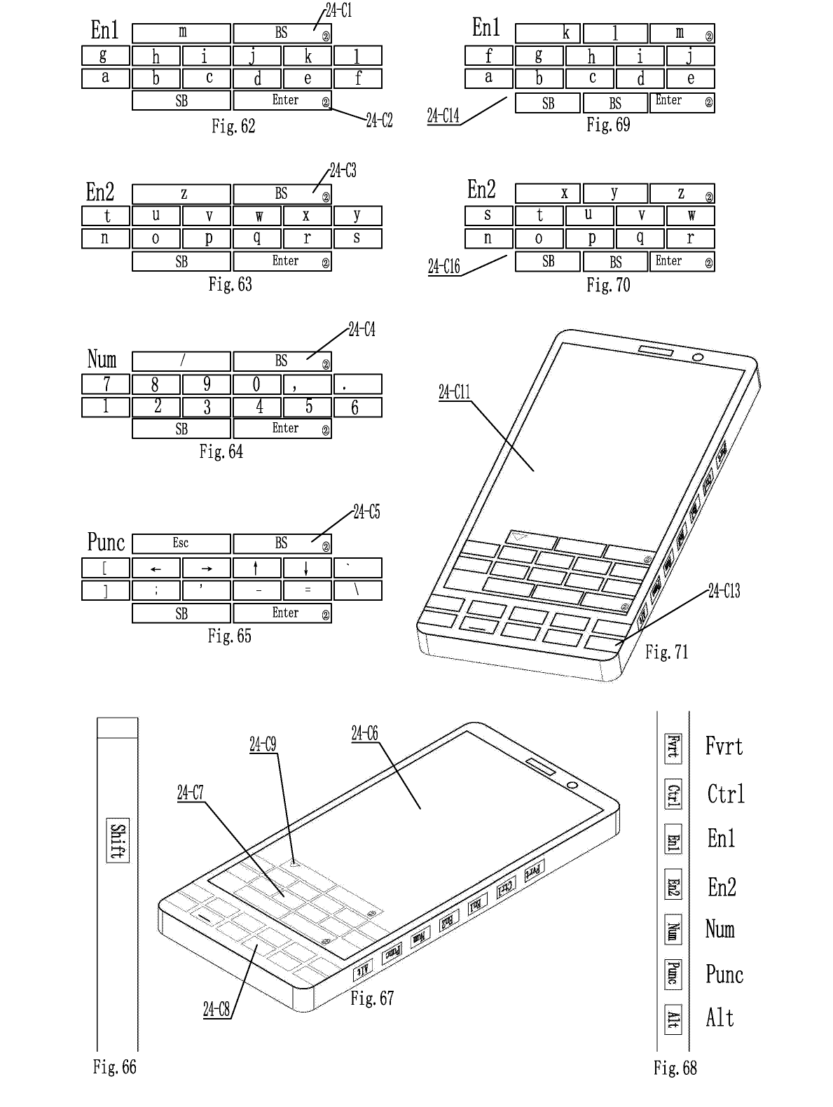

A current layout of the physical keyboard 24-C8 is mapped to the mapping keyboard 24-C7 which is a graphical and intuitive keyboard layout to facilitate a user to operate the physical keyboard 24-C8 easily. For example, if the side-key En1 configured at the right side of the phone as shown in FIG. 68 is operated currently, the current layout of the physical keyboard 24-C8 is 24-C1 as shown in FIG. 62 and mapped to the mapping keyboard 24-C7 to prompt a user to input characters or commands labeled on the layout. With the mapping keyboard 24-C7, a user need not remember complicated and multifold layouts of the physical keyboard 24-C8. And 24-C1, 24-C3, 24-C4 and 24-C5 as shown in FIG. 62-65 are a part of layouts of the physical keyboard 24-C8 respectively corresponding to the side-keys: En1, En2, Num and Punc configured at the right side of the phone as shown in FIG. 68.

In the layout 24-C1 as shown in FIG. 62, a row of physical keys: g, h, i, j, k and 1 one-to-one correspond to the upper row of real physical keys of the physical keyboard 24-C8 from left to right and are accompanied by a row of extension keys: m and BS, the extension key: m corresponds to the two physical keys: h and i, and the extension key: BS corresponds to the two physical keys: j and k; besides, a row of physical keys: a, b, c, d, e and f one-to-one correspond to the lower row of real physical keys of the physical keyboard 24-C8 from left to right and is accompanied by a row of extension keys: SB and Enter, the extension key: SB corresponds to the two physical keys: b and c, and the extension key: Enter corresponds to the two physical keys: d and e. Both of the two extension key rows are labeled with a sign \textcircled{2} 24-C2 at the end of them. The sign \textcircled{2} 24-C2 is used to prompt a user that each extension key in an extension key row is realized by means of simultaneously pressing down and releasing two corresponding physical keys of a accompanied physical key row. For example, the extension key: Enter is realized by means of simultaneously pressing down and releasing two corresponding physical keys: d and e, in other words, the fourth and fifth (counting from left to right) real physical keys of the lower real physical key row of the physical keyboard 24-C8 by right ring and little fingers, and the extension key: SB is realized by means of simultaneously pressing down and releasing two corresponding physical keys: b and c, in other words, the second and third (counting from left to right) real physical keys of the lower physical key row of the physical keyboard 24-C8 by right index and middle fingers, and so on.

It is important to reasonably arrange accompanying extension key rows and accompanied physical key rows to graphically and clearly show a corresponding relation between an extension key of an accompanying extension key row and multiple physical keys of an accompanied physical key row to facilitate a user to see the corresponding relation intuitively and easily.

A triangular button 24-C9 is used to closed or open the mapping keyboard 24-C7. After a user remembers all layouts of the physical keyboard 24-C8, showing the mapping keyboard 24-C7 is necessary no longer.

Besides showing a current layout of the physical keyboard 24-C8, the mapping keyboard 24-C7 itself can also be configured to be a touch keyboard, and meanwhile the triangular button 24-C9 is removed.

As shown in FIG. 66, a Shift side-key is configured at the left side of FIG. 67 phone, and besides En1, En2, Num and Punc, more side-keys such as Fvrt, Ctrl and Alt is also configured at the right side of FIG. 67 phone as shown in FIG. 68.

The above-mentioned “row” can also be expressed in “column” if necessary.

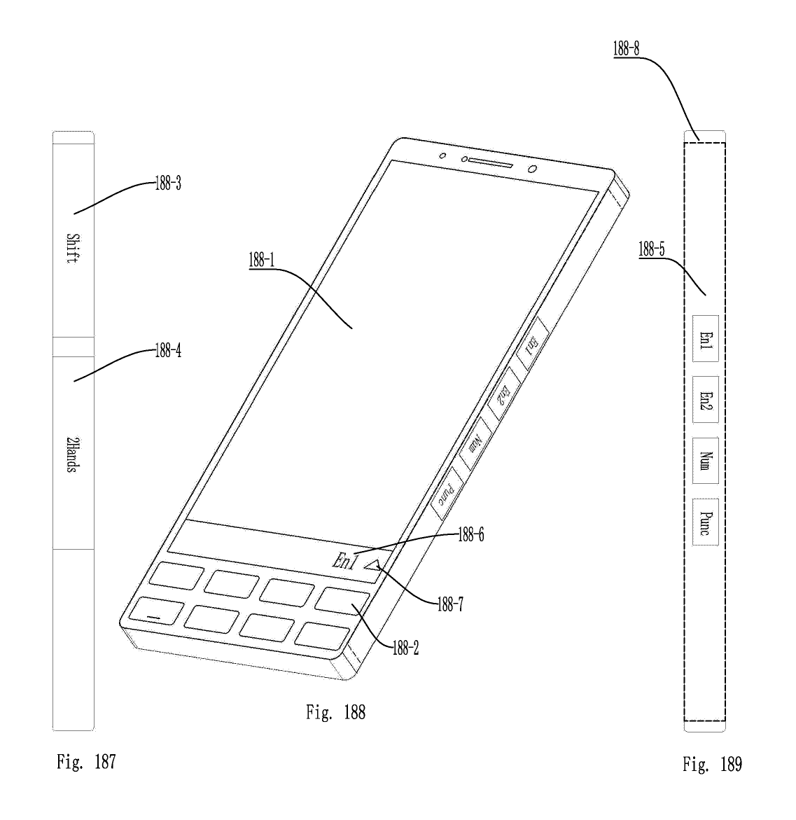

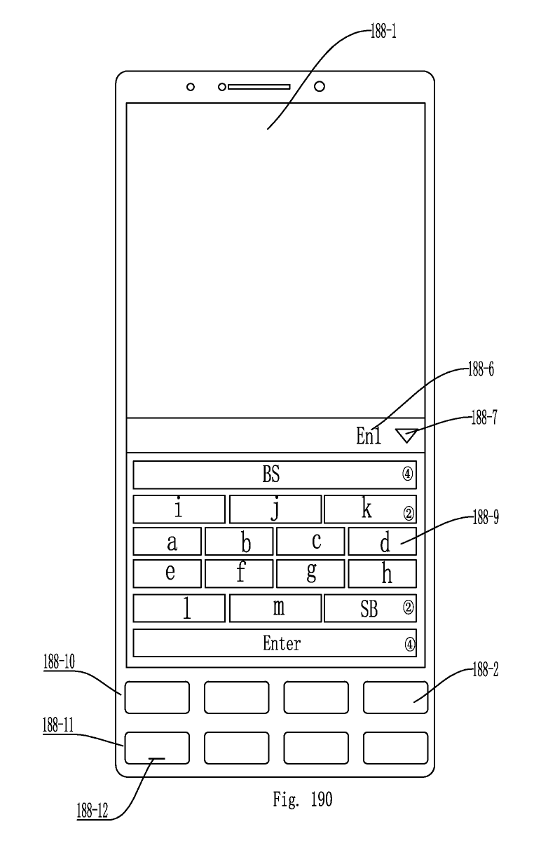

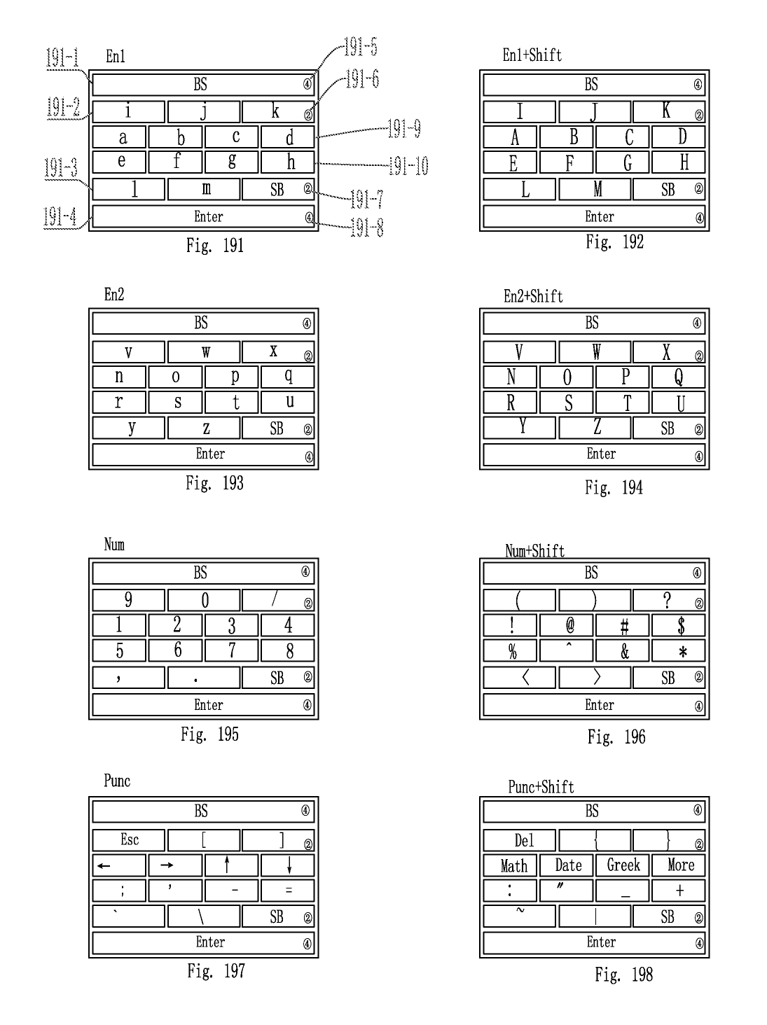

FIG. 187-198 is added newly in this continuation-in-part application and is a solution for a keyboard of a mobile phone as shown in FIG. 188. A main keyboard of FIG. 188 phone comprises a physical keyboard 188-2 configured at the bottom of the phone and a mapping keyboard 188-9 configured on a touch screen 188-1 of the phone as shown in FIG. 190. A button 188-7 is configured on the touch screen and used to close or open the mapping keyboard 188-9. FIG. 190 shows a situation of the mapping keyboard being opened and FIG. 188 shows a situation of the mapping keyboard being closed. On the lower left key of the physical keyboard 188-2 is a finger-positioning mark 188-12.

Two side-keys: Shift 188-3 and 2Hands 188-4 both of which are touch keys are configured at the left side of FIG. 188 phone as shown in FIG. 187, and Four side-keys: En1, En2, Num and Punc are configured on a multi-touch pad 188-5 at the right side of FIG. 188 phone as shown in FIG. 189. A broken line box 188-8 shows the range of the touch pad 188-5. And Both Shift 188-3 and 2Hands 188-4 can also be configured on one multi-touch pad. A side-key indicator 188-6 is configured on the touch screen 188-1 and used to indicate a currently operated side-key.

FIG. 191-198 are layouts of the physical keyboard 188-2 respectively corresponding to side-keys or side-key combinations: En1, En1 +Shift, En2, En2+Shift, Num, Num+Shift, Punc and Punc+Shift as labeled at the upper left corner of each layout.

When the side-key En1 is operated currently, the mapping keyboard 188-9 shows FIG. 191 layout and the side-key indicator 188-6 shows “En1 ” as shown in FIG. 190.

In FIG. 191 layout, a row of keys: a, b, c and d 191-9 one-to-one correspond to a row of real physical keys 188-10 of the physical keyboard 188-2 and a row of keys: e, f, g and h 191-10 one-to-one correspond to a row of real physical keys 188-11 of the physical keyboard 188-2. The physical key row 191-9 is accompanied by two extension key rows 191-2 and 191-1. The physical key row 191-10 is accompanied by two extension key rows 191-3 and 191-4.

The extension key row 191-2 is labeled with a sign \textcircled{2} 191-6 at its end, and each extension key of which corresponds to two physical keys of the accompanied physical key row 191-9, for example, the extension key: i corresponds to two physical keys: a and b, j to b and c, and k to c and d. The sign \textcircled{2} 191-6 prompts a user that each extension key of the extension key row 191-2 is realized by means of simultaneously pressing down and releasing two corresponding physical keys of the accompanied physical key row 191-9. For example, the extension key: i is realized by means of simultaneously pressing down and releasing the two corresponding physical keys: a and b, i.e., simultaneously pressing down and releasing the first and second(counting from left to right) real physical keys of the real physical key row 188-10 of the physical keyboard 188-2 by right index and middle fingers; the extension key: j is realized by means of simultaneously pressing down and releasing the two corresponding physical keys: b and c, i.e., simultaneously pressing down and releasing the second and third real physical keys of the real physical key row 188-10 of the physical keyboard 188-2 by right middle and ring fingers; and the extension key: k is realized by means of simultaneously pressing down and releasing the two corresponding physical keys: c and d, i.e., simultaneously pressing down and releasing the third and fourth real physical keys of the real physical key row 188-10 of the physical keyboard 188-2 by right ring and little fingers.

The extension key row 191-1 is labeled with a sign \textcircled{4} 191-5 at its end, and each extension key of which corresponds to four physical keys of the accompanied physical key row 191-9, for example, the extension key: BS corresponds to four physical keys: a, b, c and d. The sign \textcircled{4} 191-5 prompts a user that each extension key of the extension key row 191-1 is realized by means of simultaneously pressing down and releasing four corresponding physical keys of the accompanied physical key row 191-9. For example, the extension key: BS is realized by means of simultaneously pressing down and releasing the four corresponding physical keys: a, b, c and d, i.e., simultaneously pressing down and releasing the first, second, third and fourth (counting from left to right) real physical keys of the real physical key row 188-10 of the physical keyboard 188-2 by right index, middle, ring and little fingers.

The physical key: a, b, c or d of the physical key row 191-9 is operated respectively by means of operating the first, second, third or fourth (counting from left to right) real physical key of the real physical key row 188-10 of the physical keyboard 188-2 by a right index, middle, ring or little finger.

The extension key row 191-3 is labeled with a sign \textcircled{2} 191-7 at its end, and each extension key of which corresponds to two physical keys of the accompanied physical key row 191-10, for example, the extension key: 1 corresponds to two physical keys: e and f, m to f and g, and SB to g and h. The sign \textcircled{2} 191-7 prompts a user that each extension key of the extension key row 191-3 is realized by means of simultaneously pressing down and releasing two corresponding physical keys of the accompanied physical key row 191-10. For example, the extension key: 1 is realized by means of simultaneously pressing down and releasing the two corresponding physical keys: e and f, i.e., simultaneously pressing down and releasing the first and second(counting from left to right) real physical keys of the real physical key row 188-11 of the physical keyboard 188-2 by right index and middle fingers; the extension key: m is realized by means of simultaneously pressing down and releasing the two corresponding physical keys: f and g, i.e., simultaneously pressing down and releasing the second and third real physical keys of the real physical key row 188-11 of the physical keyboard 188-2 by right middle and ring fingers; and the extension key: SB is realized by means of simultaneously pressing down and releasing the two corresponding physical keys: g and h, i.e., simultaneously pressing down and releasing the third and fourth real physical keys of the real physical key row 188-11 of the physical keyboard 188-2 by right ring and little fingers.

The extension key row 191-4 is labeled with a sign \textcircled{4} 191-8 at its end, and each extension key of which corresponds to four physical keys of the accompanied physical key row 191-10, for example, the extension key: Enter corresponds to the four physical keys: e, f, g and h. The sign \textcircled{4} 191-8 prompts a user that each extension key of the extension key row 191-4 is realized by means of simultaneously pressing down and releasing four corresponding physical keys of the accompanied physical key row 191-10. For example, the extension key: Enter is realized by means of simultaneously pressing down and releasing the four corresponding physical keys: e, f, g and h, i.e., simultaneously pressing down and releasing the first, second, third and fourth (counting from left to right) real physical keys of the real physical key row 188-11 of the physical keyboard 188-2 by right index, middle, ring and little fingers.

The physical key: e, f, g or h of the physical key row 191-10 is operated respectively by means of operating the first, second, third or fourth (counting from left to right) real physical key of the real physical key row 188-11 of the physical keyboard 188-2 by a right index, middle, ring or little finger.

The FIG. 192-198 layouts are the same as the FIG. 191 layout except characters and some of commands and described no longer.

The present invention includes using a rectangular coordinate system, but not limited to using a rectangular coordinate system, any other applicable coordinate system can be used.

Either a touch pad or a touch screen is a kind of touch-sensitive surface being able to detect a touch(es) of a hand and its finger.

In the present invention, the side-keys can also be used as independent keys/buttons, i.e., do not necessarily have to serve as a part of a keyboard.

Besides, configuring a corresponding side-key or key/button at each holding position or touch position of a hand and its fingers, is not necessary if such a configuration is not required in an actual application situation.

1. A method operating a key/button, comprising, a finger holding the key/button is released first and then using the finger to press down or touch the key/button to hold the key/button again, the key/button is held both before and after an operation of the key/button and is released for an instant or a period of time only in the middle of the operation.

2. The method of claim 1, the key/button is also a holding position of a device in which the key/button is configured, and the device is held at least through holding the key/button.

3. The method of claim 2, besides the key/button, one or more key(s)/button(s) similar to the key/button is/are configured in the device.

4. The method of claim 2, the key/button is a physical key/button.

5. The method of claim 2, the key/button is a touch key/button.

6. The method of claim 1, the key/button is configured on a touch-sensitive surface, and the touch-sensitive surface is also a holding surface of a device where the touch sensitive surface is configured, and the device is held at least through holding the touch-sensitive surface.

7. The method of claim 6, besides the key/button, one or more key(s)/button(s) similar to the key/button is/are configured on the touch-sensitive surface.

8. The method of claim 7, the positions of all of the keys/buttons configured on the touch-sensitive surface are predetermined and fixed.

9. The method of claim 7, the positions of all of the keys/buttons configured on the touch-sensitive surface are dynamically determined.

10. The method of claim 9, furthermore comprising,
initially, the positions of all of the keys/buttons are configured to be undetermined, and
at any time, if detecting a predefined number of touch points on the touch sensitive surface, i.e., a predefined number of fingers hold and touch the touch sensitive surface, the positions of all of the keys/buttons are configured to be the positions of the touch points; and
after that, at any time, if detecting none of touch points on the touch sensitive surface, i.e., all of the fingers holding and touching the touch sensitive surface are released and leave the touch sensitive surface, the positions of all of the keys/buttons are configured to be undetermined again.

11. The method of claim 9, furthermore comprising,
at any time when the positions of all of the keys/buttons are undetermined, if detecting a predefined number of touch points on the touch sensitive surface, i.e., a predefined number of fingers hold and touch the touch sensitive surface, the positions of all of the keys/buttons are configured to be the positions of the touch points; and
after that, at any time, if detecting none of touch points on the touch sensitive surface, i.e., all of the fingers holding and touching the touch sensitive surface are released and leave the touch sensitive surface, the positions of all of the keys/buttons are configured to be undetermined again.

12. A method operating a key/button, comprising, a finger touching the key/button is released first and then using the finger to touch the key/button again, the key/button is touched both before and after an operation of the key/button, and is de-touched or is not touched for an instant or a period of time only in the middle of the operation.

13. The method of claim 12, the key/button is configured on a touch-sensitive surface, and besides the key/button, one or more key(s)/button(s) similar to the key/button is configured on the touch-sensitive surface.

14. The method of claim 13, the positions of all of the keys/buttons configured on the touch-sensitive surface are dynamically determined.

15. The method of claim 14, furthermore comprising,
initially, the positions of all of the keys/buttons are configured to be undetermined, and
at any time, if detecting a predefined number of touch points on the touch sensitive surface, i.e., a predefined number of fingers touch the touch sensitive surface, the positions of all of the keys/buttons are configured to be the positions of the touch points; and
after that, at any time, if detecting none of touch points on the touch sensitive surface, i.e., all of the fingers touching the touch sensitive surface are released and leave the touch sensitive surface, the positions of all of the keys/buttons are configured to be undetermined again.

16. The method of claim 14, furthermore comprising,
at any time when the positions of all of the keys/buttons are undetermined, if detecting a predefined number of touch points on the touch sensitive surface, i.e., a predefined number of fingers touch the touch sensitive surface, the positions of all of the keys/buttons are configured to be the positions of the touch points; and
after that, at any time, if detecting none of touch points on the touch sensitive surface, i.e., all of the fingers touching the touch sensitive surface are released and leave the touch sensitive surface, the positions of all of the keys/buttons are configured to be undetermined again.

17. A keyboard, comprising,
a physical keyboard, two or more keys of which are simultaneously pressed down and released to realize an extension key, and
a mapping keyboard configured on a display, to which a current layout of the physical keyboard is mapped to help a user to operate the physical keyboard, and
in a layout of the physical keyboard, there are at least a physical key row corresponding to a real physical key row of the physical keyboard and at least an extension key row, and each physical key row is accompanied by at least an extension key row each extension key of which is realized by means of simultaneously pressing down and releasing two or more corresponding physical keys of the accompanied physical key row, and
in a layout of the physical keyboard, each extension key row is labeled with a sign to prompt a user the number of physical keys operated simultaneously of a accompanied physical key row for an extension key of the extension key row each extension key of which graphically and intuitively corresponds to operated physical keys of the accompanied physical key row.

18. The keyboard of claim 17, the mapping keyboard is configured to be a touch keyboard.
